(19) United States
(12) Patent Application Publication
(10) Pub. No.: US 2026/0095285 A1
(43) Pub. Date: Apr. 2, 2026

(54) CROSS-RADIO ACCESS TECHNOLOGY PROTOCOL

(71) Applicant: Apple Inc., Cupertino, CA (US)

(72) Inventors: Amr Abdelrahman Yousef Abdelrahman Mostafa, Munich (DE); Alperen Gundogan, Munich (DE); Christian Hofmann, Munich (DE); Panagiotis Botsinis, Munich (DE); Sameh M. Eldessoki, Munich (DE); Tarik Tabet, Carlsbad, CA (US)

(21) Appl. No.: 19/339,152

(22) Filed: Sep. 24, 2025

(30) Foreign Application Priority Data
Sep. 27, 2024 (GR) 20240100663

(51) Int. Cl. H04L 5/00; H04B 7/06; H04L 1/1812; H04L 27/26

(52) U.S. Cl. CPC H04L 5/0048; H04B 7/0632; H04L 1/1812; H04L 27/2607

(57) ABSTRACT

In accordance with aspects of the present disclosure, a user equipment (UE) may be configured with a single protocol stack that supports access to multiple radio access technologies (RATs). Unlike conventional protocol stacks, the operations typically handled by the medium access control (MAC) and physical (PHY) layers may be separated into RAT-independent operations (which are common to all RATs) and RAT-dependent operations (which are specific to a particular RAT). The RAT-independent operations can then be handled by a single Medium Access Protocol (MAP) layer. The RAT-dependent operations can be handled by a dedicated Radio Access Protocol (RAP) layer. Hence, a UE that supports multiple RATs may have one MAP layer and multiple RAP layers (one for each RAT). The rest of the protocol stack may be agnostic to (e.g., shared by) the various RATs.

### CROSS-REFERENCE TO RELATED APPLICATION

This application claims priority to Greek Patent Application No. 20240100663, filed on Sep. 27, 2024, the entirety of which is incorporated herein by reference.

### TECHNICAL FIELD

The present disclosure relates generally to wireless communication, and more specifically to a cross-radio access technology (RAT) protocol.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards. The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

One aspect of the present disclosure relates to a method including: receiving, at a medium access protocol (MAP) layer, a data payload; converting, by the MAP layer, the data payload to a pre-radio payload by performing one or more cross-radio access technology (RAT) operations applicable (e.g., common) to a set of RATs; and outputting the pre-radio payload from the MAP layer to a first radio access protocol (RAP) layer of a set of RAP layers corresponding to the set of RATs, the first RAP layer being associated with the first RAT.

Another aspect of the present disclosure relates to a method including: receiving a radio payload at a first radio RAP layer of a set of RAP layers corresponding to a set of RATs, the first RAP layer being associated with a first RAT of the plurality of RATs; converting, by the first RAP layer, the radio payload to a pre-radio payload by performing one or more RAT-dependent operations specific to the first RAT; and outputting the pre-radio payload from the first RAP layer to a MAP layer.

Another aspect of the present disclosure relates to a method including: converting, by a first protocol layer, a data payload to a pre-radio payload by performing a first set of RAT-dependent operations associated with a first RAT of a set of RATs; selecting, from a set of RAP layers corresponding to the set of RATs, a first RAP layer associated with the first RAT; and outputting the pre-radio payload from the first protocol layer to the first RAP layer associated with the first RAT.

Another aspect of the present disclosure relates to a method including: receiving a radio payload at a first RAP layer of a set of RAP layers corresponding to a set of RATs; converting, by the first RAP layer, the radio payload to a pre-radio payload by performing a first set of RAT-dependent operations associated with a first RAT of the set of RATs; and outputting the pre-radio payload from the first RAP layer to a first protocol layer associated with the first RAT.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF FIGURES

FIG. 1 illustrates an example wireless network, according to some implementations.

FIG. 2 illustrates an example protocol stack, according to some implementations.

FIG. 3 illustrates a schematic diagram of an example cross-RAT communication protocol, according to some implementations.

FIGS. 4A and 4B illustrate an example protocol stack interface, according to some implementations.

FIGS. 5-7 illustrate example signaling diagrams, according to some implementations.

FIG. 8 illustrates an example multi-RAT spectrum sharing communication scheme, according to some implementations.

FIG. 9 illustrates a schematic diagram of cross-RAT protocol stack, according to some implementations.

FIG. 10A illustrates a flowchart of an example cross-RAT transmission scheme, according to some implementations.

FIG. 10B illustrates a process flow of an example cross-RAT transmission scheme, according to some implementations.

FIG. 11A illustrates a flowchart of an example cross-RAT retransmission scheme, according to some implementations.

FIG. 11B illustrates a process flow of an example cross-RAT retransmission scheme, according to some implementations.

FIG. 12A illustrates a flowchart of an example cross-RAT reception scheme, according to some implementations.

FIG. 12B illustrates a process flow of an example cross-RAT reception scheme, according to some implementations.

FIG. 13A illustrates a system diagram of an example cross-RAT mobility scheme, according to some implementations.

FIG. 13B illustrates a process flow of an example cross-RAT mobility scheme, according to some implementations.

FIG. 14 illustrates an example cross-RAT carrier aggregation (CA) scheme, according to some implementations.

FIG. 15A illustrates a system diagram of an example cross-RAT CA scheme, according to some implementations.

FIG. 15B illustrates a process flow of an example cross-RAT CA scheme, according to some implementations.

FIG. 16A illustrates a system diagram of an example cross-RAT CA scheme, according to some implementations.

FIG. 16B illustrates a process flow of an example cross-RAT CA scheme, according to some implementations.

FIGS. 17 and 18 illustrate example signaling diagrams, according to some implementations.

FIGS. 19-22 illustrate flowcharts of example methods, according to some implementations.

FIG. 23 illustrates an example UE, according to some implementations.

FIG. 24 illustrates an example access node, according to some implementations.

### DETAILED DESCRIPTION

Many wireless communication schemes use a hierarchical structure of communication protocol operations (known as a protocol stack) to manage the flow of data between devices. In conventional protocol stacks, the Medium Access Control (MAC) and Physical (PHY) protocol layers manage access to the radio interface and coordinate usage of available radio spectrum resources. The MAC layer typically manages operations like multiplexing/demultiplexing of data, scheduling and prioritization, feedback and retransmission, resource allocation, etc. The PHY layer typically manages operations like signal modulation and demodulation, resource mapping, error detection, channel coding, and so on.

In some wireless communication schemes, each Radio Access Technology (RAT), such as 3GPP Fourth Generation (4G) Long Term Evolution (LTE), 3GPP Fifth Generation (5G) New Radio (NR), 3GPP Sixth Generation (6G), among others, has a dedicated protocol stack. For example, a User Equipment (UE) that supports 4G LTE and/or 5G NR may respectively use a first protocol stack to communicate with a 4G LTE network and/or a second protocol stack to communicate with a 5G NR network. However, this approach can be somewhat inefficient because some layers/functions may be the same for both protocol stacks. For example, 4G LTE and 5G NR leverage many of the same Radio Resource Control (RRC), Packet Data Convergence Protocol (PDCP), and Radio Link Control (RLC) operations and parameters. This inefficiency can be exacerbated when additional RATs are supported, such as 6G RATs. Thus, maintaining separate protocol stacks for each RAT may be unnecessary in some implementations.

In accordance with aspects of the present disclosure, a UE may be configured with a single protocol stack that supports access to multiple RATs. Unlike conventional RAT-specific protocol stacks, the operations typically handled by the MAC and PHY layers may be separated into RAT-independent operations (which are common to all RATs) and RAT-dependent operations (which are specific to a particular RAT). The RAT-independent operations may be handled by a universal Medium Access Protocol (MAP) layer. The RAT-dependent operations may be handled by a dedicated Radio Access Protocol (RAP) layer. Hence, a UE with multi-RAT capabilities may have one MAP layer and multiple RAP layers (one for each RAT). The rest of the protocol stack may be agnostic to (e.g., shared by) the various RATs.

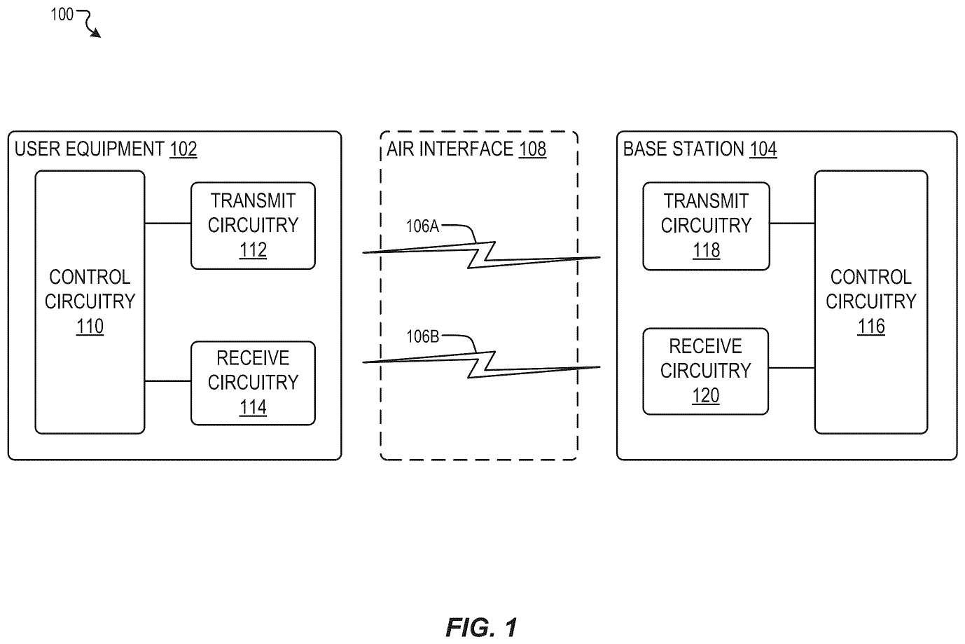

FIG. 1 illustrates a wireless network 100. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For instance, the control circuitry 110 can determine or otherwise select a RAT-dependent RAP layer and output data from a RAT-agnostic MAP layer to the selected RAP layer.

The transmit circuitry 112 can perform various operations described herein. For example, the transmit circuitry 112 can transmit one or more signals using the selected RAP layer. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 112 may be configured to receive block data from the control circuitry 110 for transmission on the air interface 108.

The receive circuitry 114 can perform various operations described herein. For instance, the receive circuitry 114 can receive one or more signals using the selected RAP layer. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, an Evolved Universal Terrestrial Radio Access Network (E-UTRAN), a non-terrestrial cell, or a legacy RAN, such as a Universal Terrestrial Radio Access Network (UTRAN). As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

The UE 102 or the base station 104, or both, in the wireless network 100 may use a protocol stack to manage the flow of data between devices. In conventional protocol stacks, the MAC and PHY protocol layers manage access to the radio interface and coordinate usage of available radio spectrum resources. The MAC layer typically manages operations like multiplexing and demultiplexing of data, scheduling and prioritization, feedback and retransmission, resource allocation, etc. The PHY layer typically manages operations like signal modulation and demodulation, resource mapping, error detection, channel coding, and so on.

In some implementations, the UE 102 may be configured with a separate protocol stack for each RAT. As an example, a UE 102 that supports both 4G LTE and 5G NR may use a first protocol stack to communicate with a 4G LTE network and a different second protocol stack to communicate with a 5G NR network. The first protocol stack and the second protocol stack may each include a separate RRC layer, SDAP layer, PDCP layer, RLC layer, MAC layer, and PHY layer. However, this approach may be inefficient because 4G LTE and 5G NR leverage many of the same RRC, PDCP, and RLC operations. Thus, maintaining separate protocol stacks for each RAT may be unnecessary.

From the UE perspective, next-generation UEs (e.g., 6G UEs) may have to support one or more legacy protocols (e.g., one or more of 5G, 4G, among others), in addition to supporting 6G RATs, to access the cellular network in areas where the radio spectrum is allocated only for the 4G and/or 5G RATs. From the network side, the cellular network may have to support legacy cellular RATs (e.g., 4G, 5G) and allocate radio spectrum to serve legacy UEs; this portion of the radio spectrum cannot be utilized to serve UEs via next-generation cellular radio protocols like 6G. With every new cellular technology (e.g., 4G, 5G, 6G), specifications for 3GPP protocol layers are developed from scratch. For many protocol layers, however, the associated functionalities/procedures in each subsequent release are nearly identical. These layers are modular and mostly self-contained. However, some configuration specific handling is exposed to the RRC layer, which makes these layers dependent on each other.

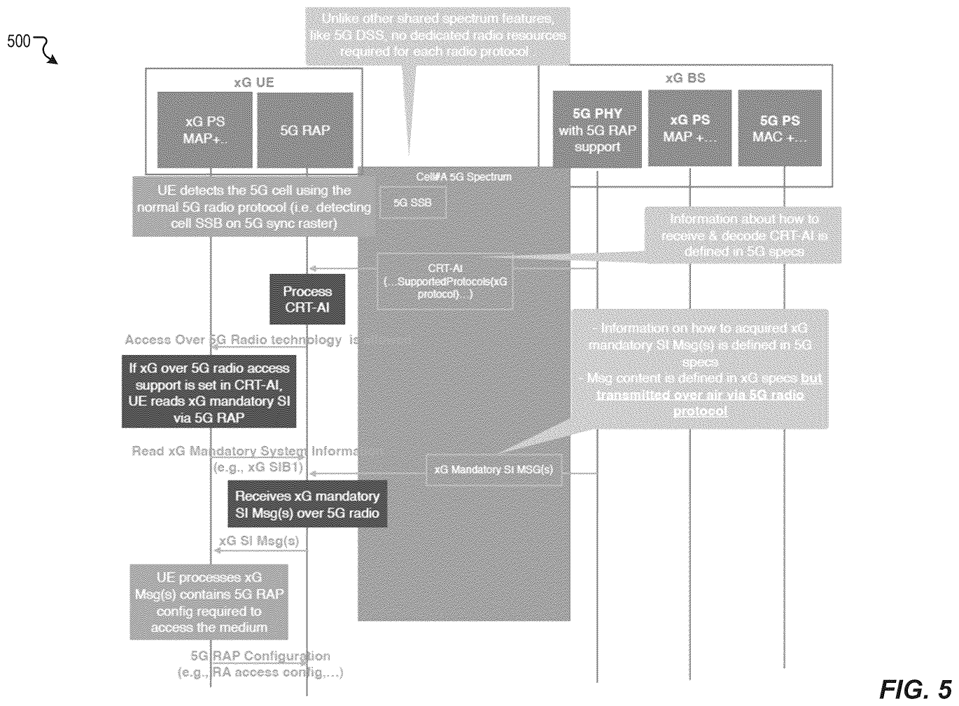

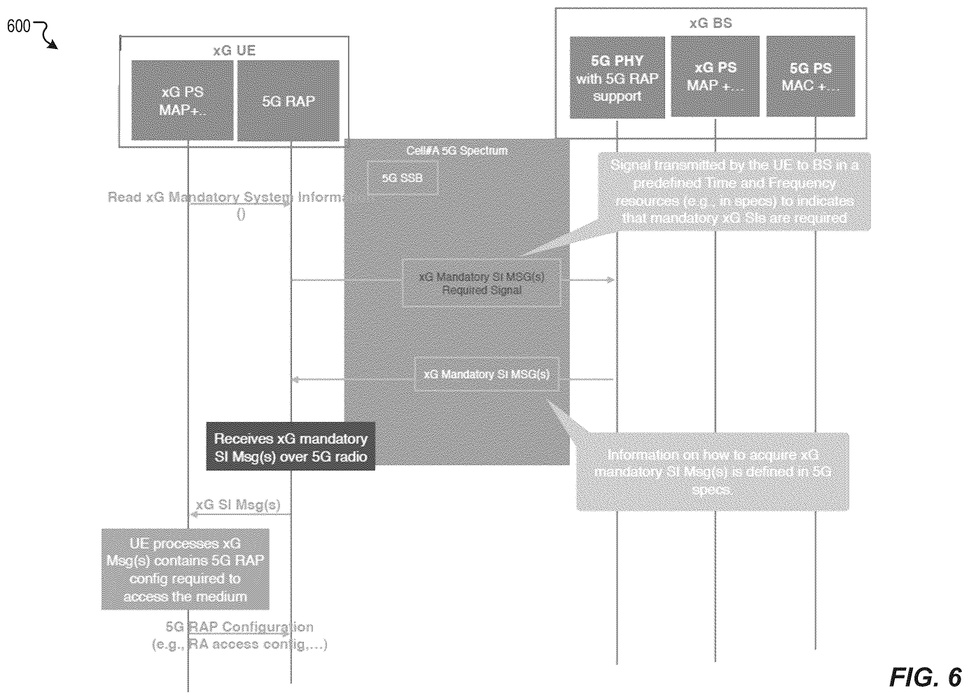

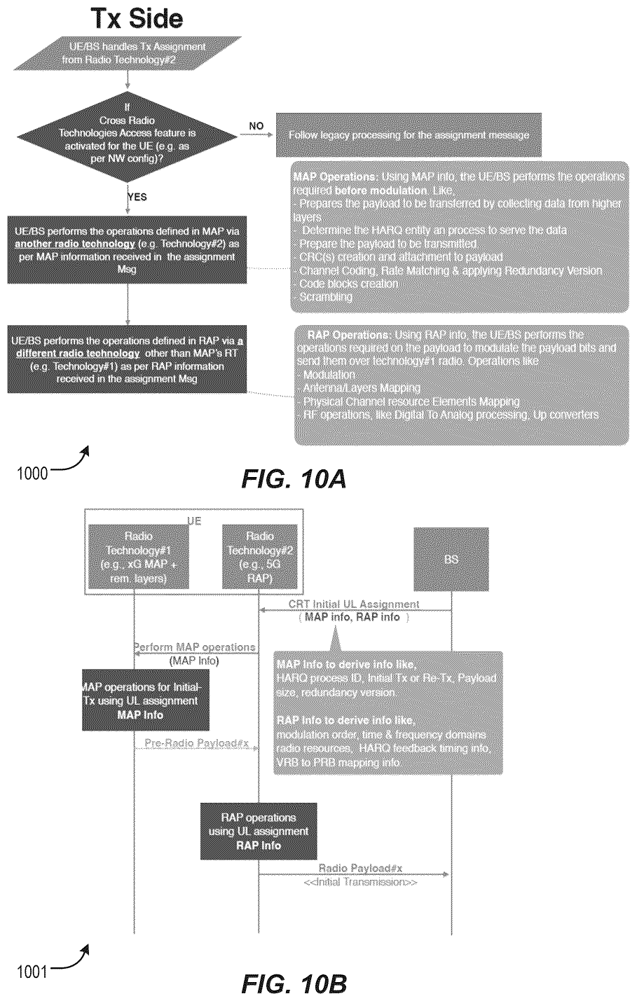

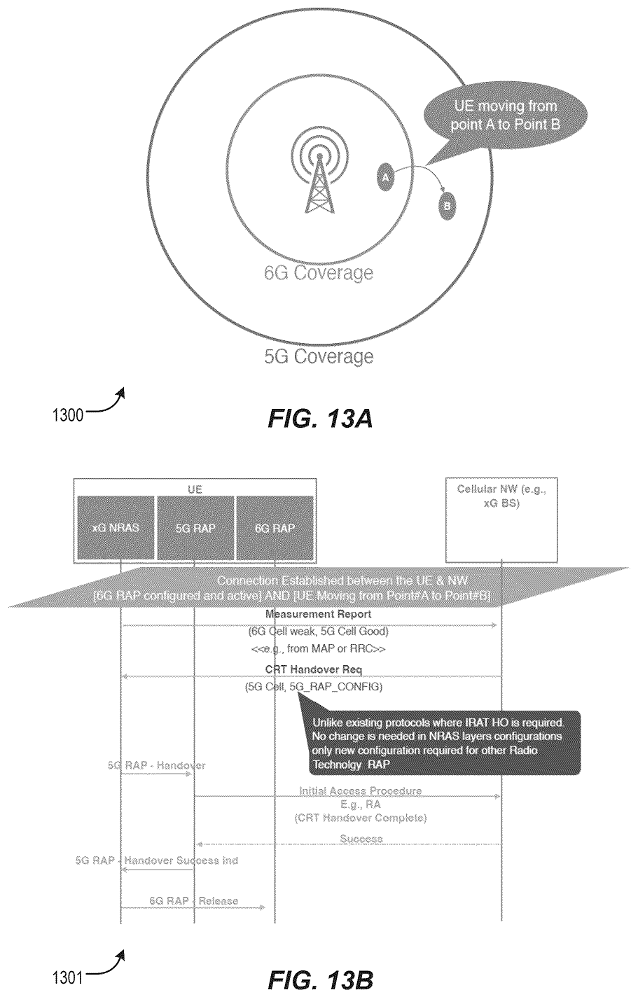

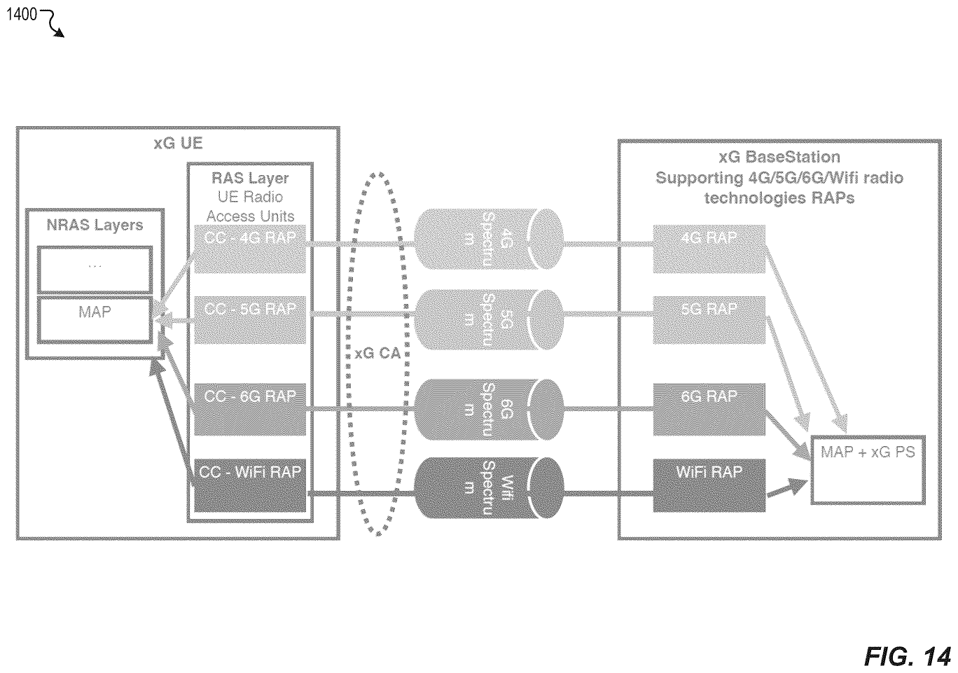

Some aspects of the present disclosure relate to a method for detecting a cellular cell that supports a cross-RAT protocol and performing initial cell access (shown and described with reference to FIGS. 5-8); a method for a UE 102 to request mandatory system information messages from a base station 104 (shown and described with reference to FIG. 6); a method for cross-RAT uplink and downlink assignment handling (shown and described with reference to FIGS. 10-12); a method for mobility between different RATs (shown and described with reference to FIGS. 13A and 13B); and a method for cross-RAT CA (shown and described with reference to FIGS. 14-18). In the following description, various techniques are described with reference to 4G and 5G as legacy RATs. However, the techniques are also applicable for other legacy RATs, such as 2G and 3G.

The cross-RAT techniques described herein are different from lightweight internet protocol (LWIP), which is a transmission control protocol/internet protocol (TCP/IP) stack that can be used to increase the capacity of legacy Wi-Fi networks and improve uplink performance. In LWIP, the split happens on the IP layer, where a determination is made to serve packets via cellular or Wi-Fi. Packets served by Wi-Fi are encapsulated via IPSec tunnel. This differs from the present disclosure, as packets are served via two separate RATs and aggregated on an IP level.

The cross-RAT techniques described herein also differ from LTE-WLAN aggregation (LWA), which is a technology that allows mobile devices to use both LTE and Wi-Fi concurrently. In LWA, the split happens on the PDCP layer, where a determination is made to serve packets via cellular or Wi-Fi using a split radio bearer (RB). This differs from the present disclosure because packets are served via two separate RATs and aggregated at the PDCP level.

The techniques described herein also differ from mobile response and stabilization services (MRSS) dynamic 5G/6G spectrum sharing techniques, where 6G cells are separately identifiable and have dedicated radio resources for SSBs (e.g., 5G and 6G cells are identified separately). In MRSS, 6G has dedicated physical channels. In the present disclosure, 5G cell physical channels are used to transfer xG messages, so specific channels are not required for xG UEs served via 5G assigned spectrum.

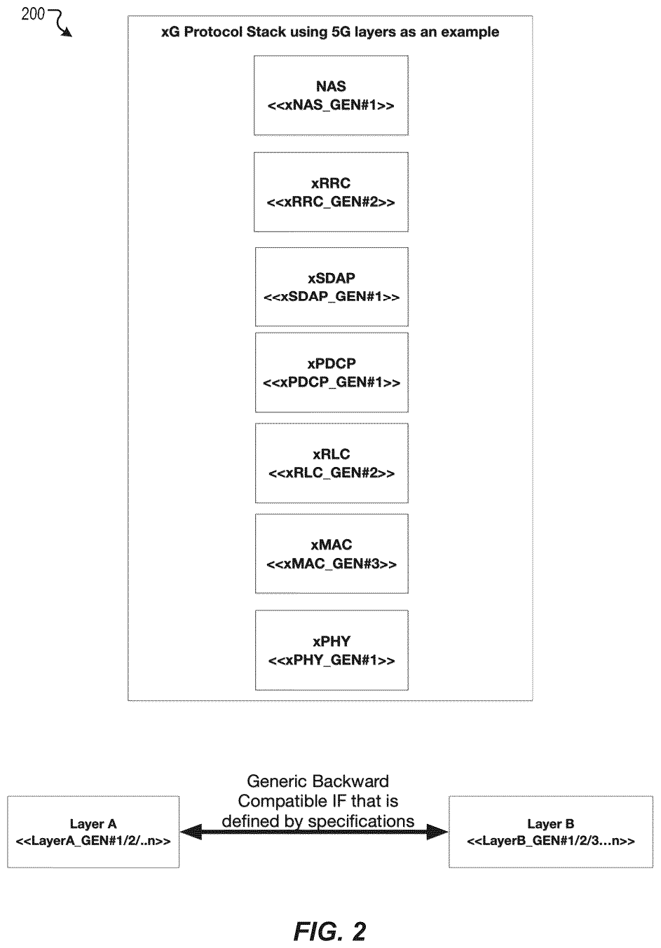

FIG. 2 illustrates an example protocol stack 200, according to some implementations. The protocol stack 200 depicted in FIG. 2 may be an xG protocol stack, using 5G protocol layers as an example. As shown in FIG. 2, the protocol stack 200 includes a non-access stratum (NAS) protocol layer <<xNAS_GEN #1>>, an xRRC protocol layer <<xRRC_GEN #2>>, an xSDAP layer <<xSDAP_GEN #1>>, an xPDCP protocol layer <<xPDCP_GEN #1>>, an xRLC protocol layer <<xRLC_GEN #2>>, an xMAC protocol layer <<xMAC_GEN #3>>, and an xPHY protocol layer <<xPHY_GEN #1>>. Some protocol layers of the protocol stack 200 may be generic backward compatible, if defined by specifications. For example, Layer A <<LayerA_GEN #1/2/ . . . n>> may be backwards compatible with Layer B <<LayerB_GEN #1/2/3 . . . n>>.

It may be desirable to develop the next generation cellular protocol, referred to herein as xG, in a way that is easily extendable for future wireless RATs and supports direct access to the cellular network via existing/legacy RATs. Each xG layer can be developed separately, without dependency on other xG layers. For example, xRRC_Gen #1 (e.g., 6G release) can be used to access the network over the xPDCP_Gen #2 physical layer (e.g., 7G release). Each layer can be abstracted from other layers, meaning each layer is independent of other layers.

Each protocol layer may provide, to other layers, a set of services that are independent from the technologies executing these services. For example, the PHY layer can provide the following services to RRC: initial cell access (e.g., requesting that PHY perform initial access on a particular cell), applying L1 configurations (e.g., via Physical Layer Configurations Request/Accept/Reject messages), and L1 capability signaling (e.g., providing L1 capabilities to be transferred to the network). Initial cell access messages/parameters include CellAccessRequest (encoded RRC message), CellAccessResponse, and CellAccessAbort.

Interfaces between these services may be defined by 3GPP specifications. Interface changes from one generation to the next are backwards compatible. Each layer performs its own configuration handling that is defined in the corresponding specification. For example, air-message content definition (e.g., ASN.1 structure if ASN.1 is used by that layer), validations, and applications. For RRC, other layer configurations can be defined as a transparent set of bytes. Each layer may define and prepare its own capability. The capabilities of each layer can then be transferred to the network, e.g., via a container in one of the RRC air-messages.

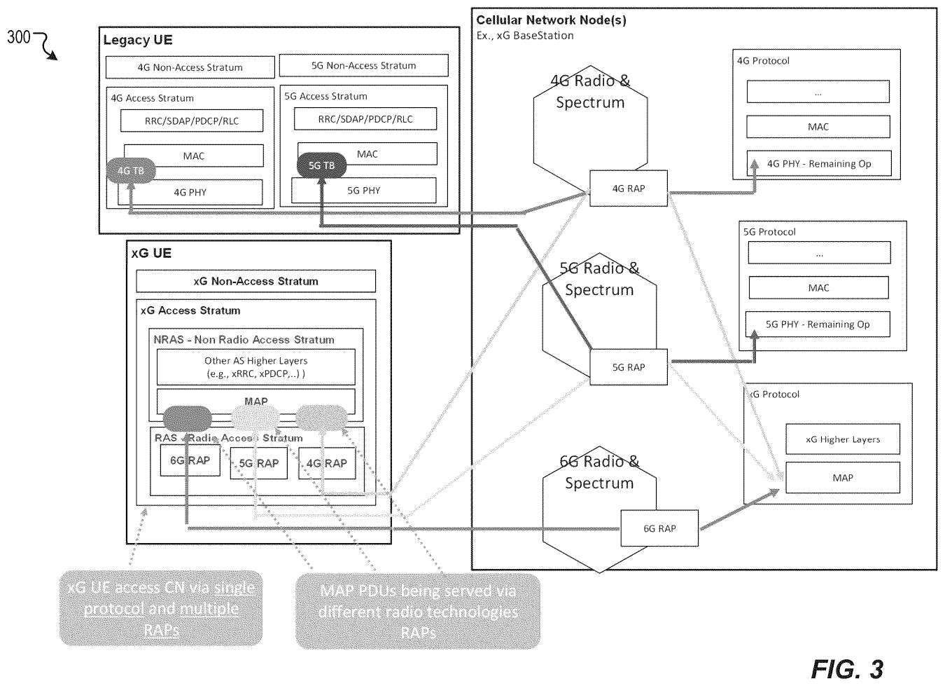

FIG. 3 illustrates a schematic diagram 300 of an example cross-RAT communication protocol, according to some implementations. The example schematic diagram 300 depicted in FIG. 3 includes a UE that supports a subset of legacy cellular protocol functionalities (e.g., not a complete set of legacy RATs), enabling the UE to access the cellular network via these legacy RATs (e.g., 3G, 4G, 5G) using a single cellular protocol, referred to herein as an xG protocol. As described in greater detail below, the xG UE can access the core network via a single MAP layer and multiple RAP layers. MAP PDUs can be served by RAT-specific RAP layers.

The MAP layer is responsible for all PHY and MAC layer operations that are not (i) related to physical radio access or (ii) dependent on radio channel structure and timing. Operations performed by the MAP layer can include (but are not limited to) MAC non-radio dependent operations like multiplexing and demultiplexing of traffic service data units (SDUs) and prioritization (e.g., similar to logical channel prioritization), discontinuous reception, HARQ and soft-combing operations, and serving cell activation/deactivation as well as PHY non-radio dependent operations like checksum generation for TBs (e.g., CRC), channel coding, rate matching, scrambling, etc.

The RAP layer is responsible for operations that enable access and transfer of bits over a particular RAT (e.g., 4G, 5G, 6G, 7G, Wi-Fi). Operations performed by the RAP layer can include (but are not limited to) defining the radio frame structure, timing, physical channels and L1 messages (e.g., DCIs), cell detection and measurement, PHY layer operations like modulation, layer mapping and pre-coding, mapping to PHY layer blocks (e.g., PRBs), L1 measurements and CQI reporting, other services related to radio access such as cell random access procedures, uplink timing advance (TA) maintenance, requesting uplink resources/grants from the network via a random access message or a scheduling request, determining where/how TB transmission/reception feedback is provided to the network, validating/applying physical channel configurations, etc. Within a base station, the radio unit (RU) may have RF and RAP functionality, the data unit (DU) may have MAP and RLC functionality, and the control unit (CU) may have PDCP functionality and other layers.

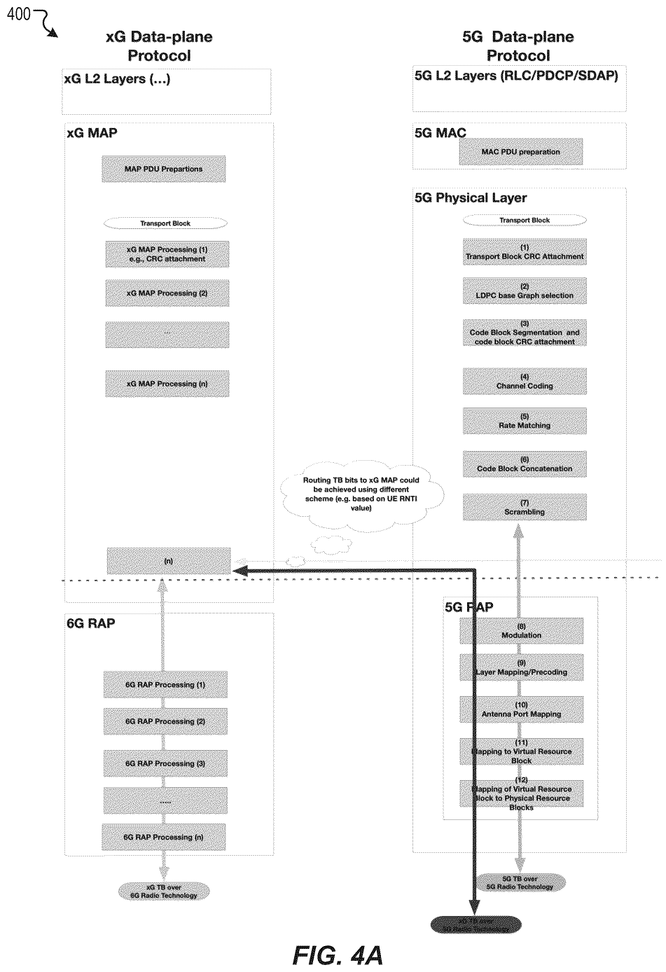

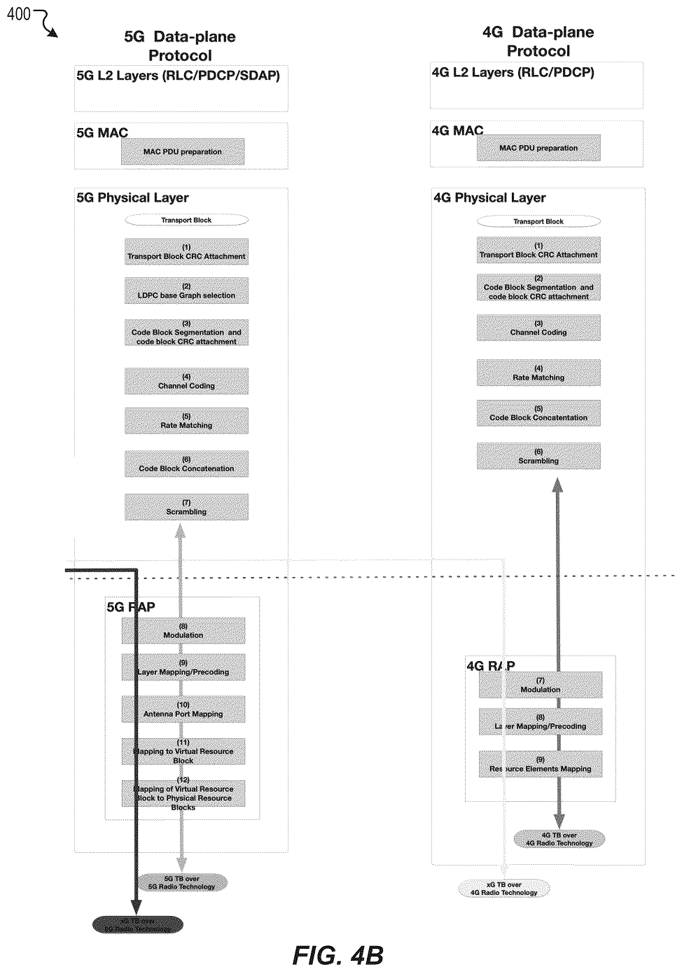

FIGS. 4A and 4B illustrate an example protocol stack interface 400, according to some implementations. The example protocol stack interface 400 shows various payload, pre-radio payload, and radio payload operations performed by an xG data plane protocol, a 5G data plane protocol, and a 4G data plane protocol. The xG data plane protocol may include an xG MAP layer that is served by one or more RAPs based on the number of RATs supported by the xG UE. The cellular network node (e.g., base station) can decide whether to process the received data from a UE via a legacy RAT protocol (e.g., 4G, 5G) or an xG protocol based on information such as a radio network temporary identifier (RNTI) assigned to the UE. Routing TB bits to the xG map can be accomplished using different schemes (e.g., based on UE RNTI value). The sequence of operations depicted in the example protocol stack interface 400 may be as follows: payload, having upper layer data to be transferred; MAP operations; pre-radio payload; RAP operations; radio payload.

FIG. 5 illustrates an example signaling diagram 500, according to some implementations. The signaling diagram 500 includes an xG UE (e.g., a UE 102 with xG capabilities) and an xG base station (e.g., a base station 104 with xG capabilities). A cellular cell (for example 5G Cell #A) may indicate, via an existing broadcast message (e.g., MIB) or a new message referred to as Cross Radio Technology Access Information (CRT-AI), whether cross-RAT access is enabled on that cell or not. The radio resources and scheme by which this message is broadcasted may be defined in 3GPP specifications for Cell #A RAT.

If the xG UE able to receive CRT-AI via Cell #A RAP and the UE has to access the network via one of Cell #A supported protocols (e.g., xG protocol) indicated in CRT-AI, the UE may start reading the supported protocol (e.g., xG) broadcasted information via Cell #A RAT-defined operations. A cellular cell for a RAT (e.g., 5G) supporting cross-RAT access may send, over physical radio resources, messages that are transmitted via RAP defined operations and having content of another protocol (e.g., xG). Information on how to acquire other mandatory RAT system information messages (e.g., xG system information messages) over Cell #A RAT (e.g., 5G) may be defined in 5G specifications. Optionally, RAP configuration can be derived from legacy technology system information.

FIG. 6 illustrates an example signaling diagram 600, according to some implementations. The signaling diagram 600 includes an xG UE (e.g., a UE 102 with xG capabilities) and an xG base station (e.g., a base station 104 with xG capabilities). To avoid continuous transmission of mandatory xG system information messages, the xG UE may send a PHY signal via pre-defined (e.g., in 3GPP specifications) time and frequency resources to indicate (to the base station) that xG mandatory system information messages are needed. After receiving the mandatory system information request signal, the base station can start broadcasting the mandatory system information messages via pre-defined time and frequency radio resources for a specified duration.

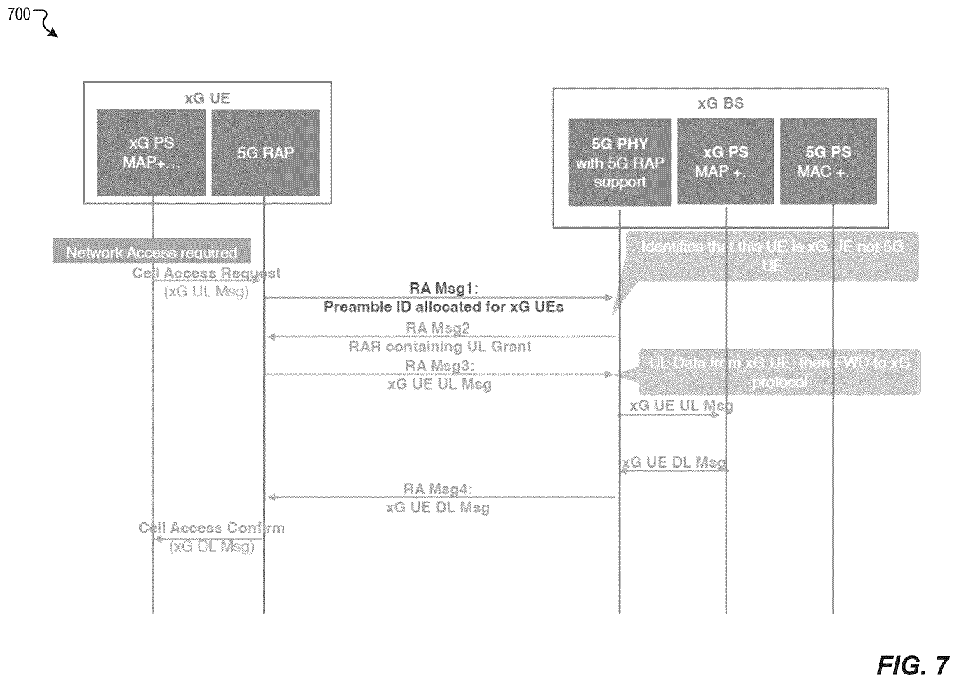

FIG. 7 illustrates an example signaling diagram 700, according to some implementations. The signaling diagram 700 includes an xG UE (e.g., a UE 102 with xG capabilities) and an xG base station (e.g., a base station 104 with xG capabilities). A cellular cell supporting cross-RAT access may indicate, via one or more broadcast messages, a list of physical radio resources (e.g., preambles IDs) that xG UEs can use to access the cellular network using a particular RAT (e.g., 5G, 6G). For example, Cell #A may specify that one or more preamble IDs are dedicated for xG UEs. Accordingly, when Cell #A receives one of these dedicated xG random access preambles, Cell #A can determine that the message is from an xG UE. Accordingly, messages exchanged during a cell access procedure (e.g., random access) can be processed using xG protocol instead of 5G protocol. An identifier assigned to the xG UE, e.g., C-RNTI, can be tagged by the Cell #A as being associated with xG UE. This information can be used for multiple purposes. For example, all communications to the UE may be routed to xG protocol instead of 5G protocol.

FIG. 8 illustrates an example multi-RAT spectrum sharing communication scheme 800, according to some implementations. The multi-RAT spectrum sharing communication scheme 800 shown in FIG. 8 includes a legacy 5G UE and an xG UE that supports 5G RAP. The multi-RAT spectrum sharing communication scheme 800 supports xG radio access to enable MRSS.

As depicted in FIG. 8, an xG base station may support 6G RAP/MAP as well as legacy 5G. To serve legacy devices (e.g., 5G UEs), the base station can host a 5G cell (e.g., Cell #A). 5G devices only detect 5G cells and access the network via 5G protocol. Although some aspects of the multi-RAT spectrum sharing communication scheme 800 are described in the context of 5G operations, the same mechanism can be used to enable 4G devices by activating 4G cells via CRT-AI. After decoding CRT-AI via Cell #A 5G RAP, new xG devices that support xG can access the 5G cell via xG protocol, using MAP and 5G RAP. Aspects of the present disclosure support MRSS spectrum sharing of 5G spectrum with xG (e.g., 6G) devices.

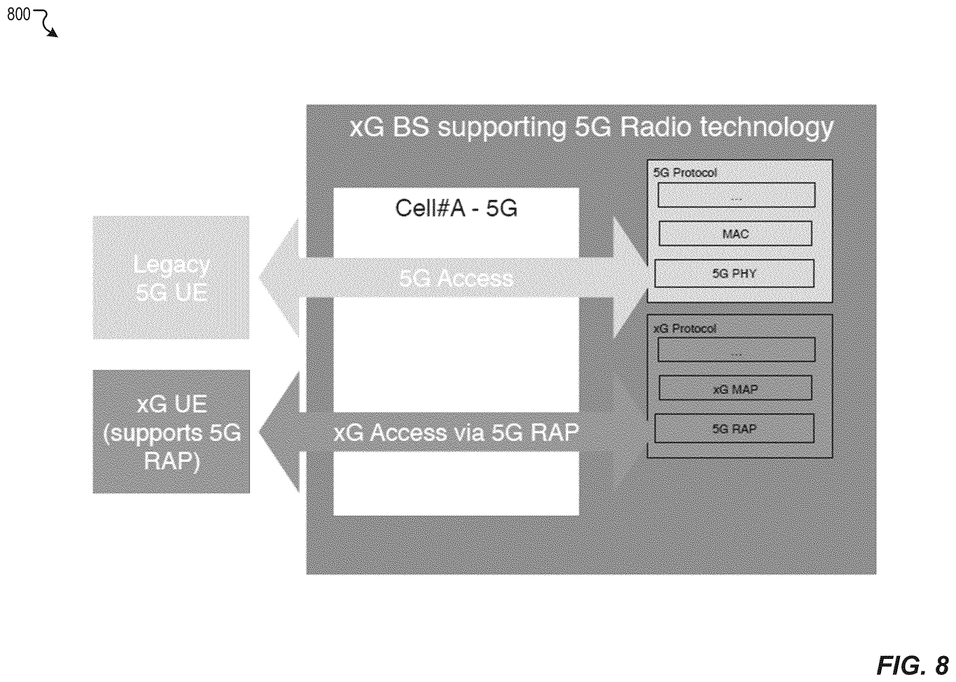

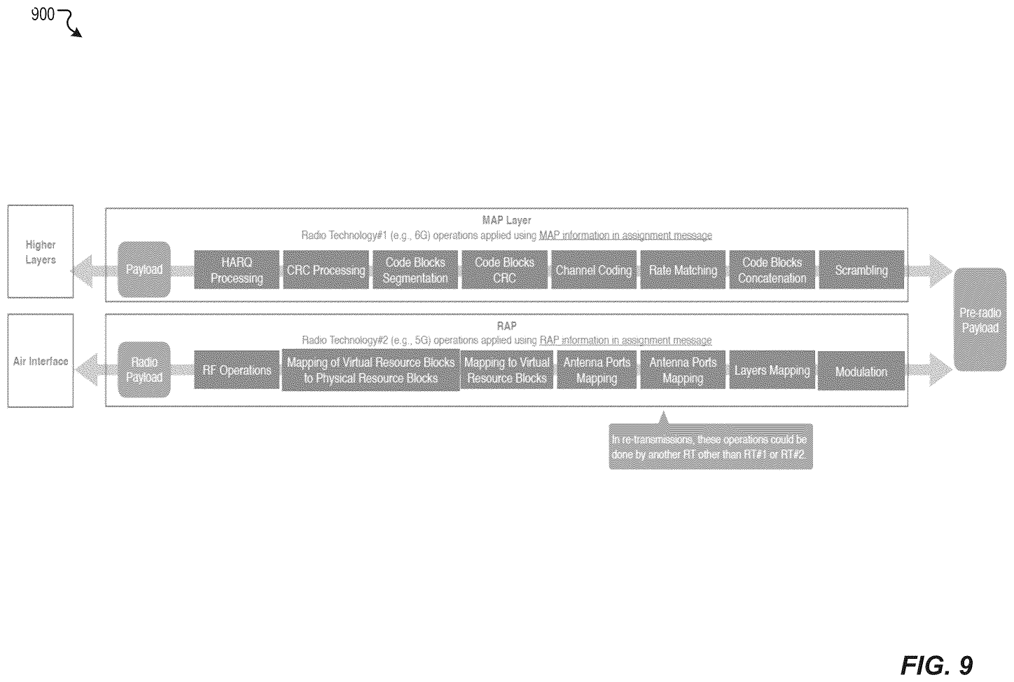

FIG. 9 illustrates a schematic diagram of a cross-RAT protocol stack 900, according to some implementations. The cross-RAT protocol stack 900 includes a MAP layer that interfaces with higher layers and a RAP layer that interacts directly with the air interface. The MAP layer handles operations for a first RAT (e.g., 6G) using MAP information from an assignment message. The RAP layer handles operations for a second RAT (e.g., 5G) using RAP information from the assignment message.

The MAP layer may handle operations such as HARQ processing, CRC processing, code block segmentation, code block CRC, channel coding, rate matching, code block concatenation, and scrambling, among other examples. The RAP layer may handle operations such as RF operations, mapping of virtual resource blocks to physical resource blocks, mapping to virtual resource blocks, antenna port mapping, layer mapping, and modulation.

For initial transmissions, the assignment message contains information for the first RAT to determine parameters for payload size, HARQ operations (like HARQ process ID, initial (re)transmission, redundancy version), channel coding rate, code block creation, and scrambling. The assignment message can also include information for the second RAT to determine parameters for the modulation scheme to be applied, physical radio resources to be utilized, antenna mapping, RF operations, etc. The assignment message can be received using the first RAT, the second RAT, or a different RAT (e.g., 4G).

For re-transmissions, the assignment message may contain information for a particular RAT to determine parameters for the modulation scheme to be applied, the physical radio resources to be utilized, antenna mapping, and/or RF operations for triggering the UE to perform retransmission for a radio payload via a RAT different from the RAT that performed these operations in the previous/initial radio payload transmission.

FIG. 10A illustrates a flowchart 1000 of an example cross-RAT transmission scheme, according to some implementations. In accordance with the cross-RAT transmission scheme depicted in FIG. 10A, a device (such as a UE or base station) handles transmission assignment for a second RAT (e.g., 5G). If cross-RAT access is not enabled for the device (e.g., as per network configuration), the device follows legacy processing rules for the assignment message.

If cross-RAT access is activated, the device performs the operations defined in MAP via the second RAT as per MAP information received in the assignment message. For example, using the MAP information, the device may perform the following operations before modulation: preparing the payload to be transferred by collecting data from higher layers; determining the HARQ entity and process to serve the data; preparing the payload for transmission; generating and attaching CRC to payload; performing channel coding, rate matching, and applying redundancy version; generating code blocks; scrambling operations.

Accordingly, the device performs the operations defined in RAP via another RAT (e.g., 6G) that is different from the RAT of the MAP layer, as per RAP information received in the assignment message. For example, using the RAP information provided, the device may perform the following operations on the payload to modulate the payload bits and send them via RAT #1: modulation; antenna/layer mapping; physical channel resource element mapping; RF operations like digital analog processing and up conversion.

FIG. 10B illustrates a process flow 1001 of an example cross-RAT transmission scheme, according to some implementations. In accordance with the cross-RAT transmission scheme depicted in FIG. 10B, a base station transmits CRT initial uplink assignment information (MAP information and RAP information) to a UE that supports a first RAT (e.g., xG) and a second RAT (e.g., 5G). The 5G RAP layer of the UE may provide the MAP information to the xG MAP layer of the UE, such that the xG MAP layer can perform MAP operations for initial transmission using the uplink assignment MAP information provided. The xG MAP layer of the UE may return a pre-radio payload to the 5G RAP layer of the UE, which may perform RAP operations using the uplink assignment RAP information provided. Accordingly, the UE may transmit the resulting radio payload <<Initial Transmission>> to the base station.

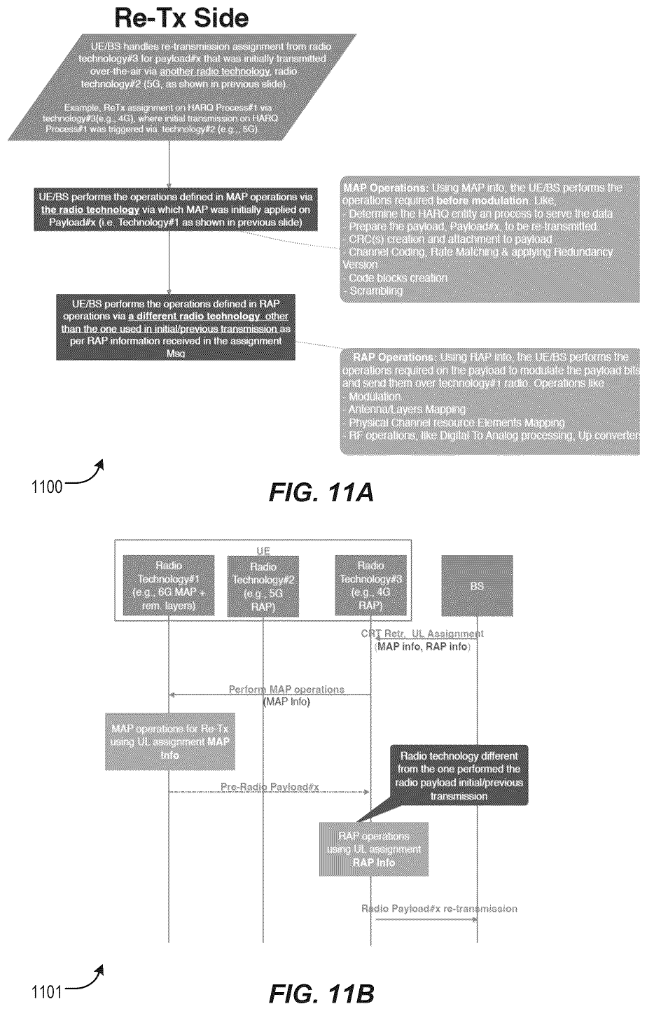

FIG. 11A illustrates a flowchart 1100 of an example cross-RAT retransmission scheme, according to some implementations. In accordance with the cross-RAT retransmission scheme depicted in FIG. 11A, a device (such as a UE or base station) handles re-transmission assignment from a third RAT (e.g., 4G) for a payload that was initially transmitted over the air via another RAT (e.g., 5G). For example, retransmission assignment on HARQ Process #1 via RAT #3 (e.g., 4G), where initial transmission on HARQ Process #1 was triggered via RAT #2 (e.g., 5G). The device performs MAP operations via the RAT which the MAP layer was initially applied on the payload (e.g., RAT #1). For example, using the MAP information, the device may perform the following operations before modulation: determining the HARQ entity and process to serve the data; preparing the payload for retransmission; generating and attaching CRC to payload; performing channel coding, rate matching, and applying redundancy version; generating code blocks; scrambling operations.

Accordingly, the device may perform RAP operations via a different RAT other than the one used for the initial/previous transmission, as per RAP information received in the assignment message. For example, using the RAP information provided, the device may perform the following operations on the payload to modulate the payload bits and send them via RAT #1: modulation; antenna/layer mapping; physical channel resource element mapping; RF operations like digital analog processing and up conversion.

FIG. 11B illustrates a process flow 1101 of an example cross-RAT retransmission scheme, according to some implementations. In accordance with the cross-RAT retransmission scheme depicted in FIG. 11B, a base station transmits CRT retransmission uplink assignment information (MAP information and RAP information) to a UE that supports a first RAT (e.g., 6G), a second RAT (e.g., 5G), and a third RAT (e.g., 4G). The 4G RAP layer of the UE sends the MAP information to the 6G MAP layer, which performs MAP operations for retransmission using the uplink assignment MAP information provided. Accordingly, the 6G MAP layer provides a pre-radio payload back to the 4G RAP layer, which performs RAP operations using the uplink assignment RAP information provided. Once complete, the UE transmits the resulting radio payload to the base station using the 4G RAP layer.

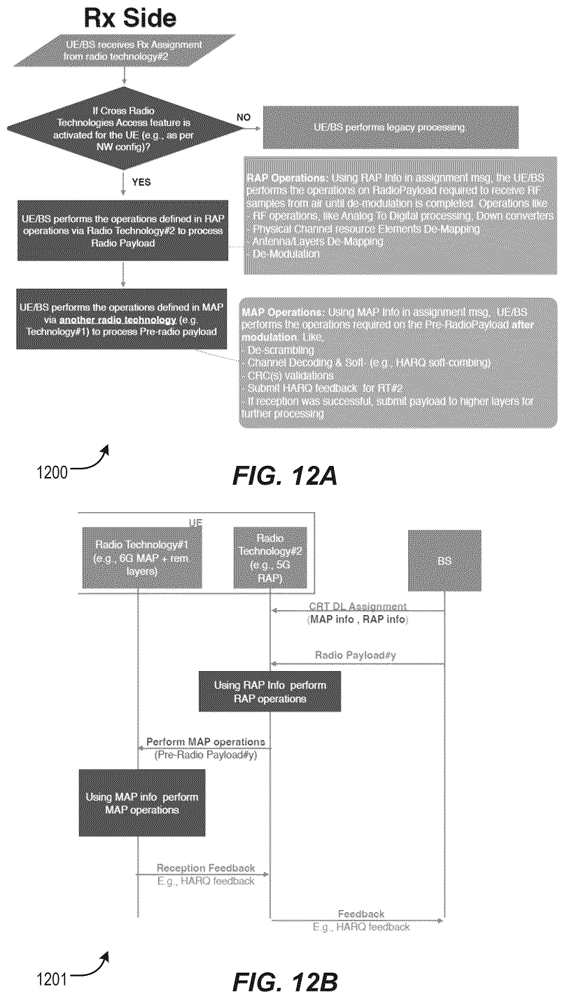

FIG. 12A illustrates a flowchart 1200 of an example cross-RAT reception scheme, according to some implementations. In accordance with the cross-RAT reception scheme depicted in FIG. 12A, a device (such as a UE or a base station) obtains reception assignment information from RAT #2 (e.g., 5G). If cross-RAT access is not activated for the device (e.g., as per network configuration), the device performs legacy processing.

If cross-RAT access is activated, the device performs RAP operations via RAT #2 to process the radio payload. For example, using the RAP information in the assignment message, the device performs the following operations on the radio payload to receive RF samples from until demodulation is complete: RF operations like analog to digital processing and down conversion; physical channel resource element de-mapping; antenna/layer de-mapping; demodulation.

Accordingly, the device performs MAP operations using a different RAT (e.g., RAT #1) to process the pre-radio payload. For example, using the MAP information in the assignment message the device may perform the following operations on the pre-radio payload after modulation: de-scrambling; channel decoding and soft-combing; CRC validation; submitting HARQ feedback for RAT #2, submitting payload to higher layers for further processing if reception is successful.

FIG. 12B illustrates a process flow 1201 of an example cross-RAT reception scheme, according to some implementations. In accordance with the cross-RAT reception scheme depicted in FIG. 12B, a base station provides CRT downlink information (MAP information and RAP information) to a UE that supports a first RAT (e.g., 6G) and a second RAT (e.g., 5G). Thereafter, the base station may transmit a radio payload to the UE. The 5G RAP layer of the UE may perform RAP operations on the radio payload and output the resulting pre-radio payload to the 6G MAP layer, which may perform MAP operations using the MAP information provided. Accordingly, the 6G MAP layer may provide reception feedback (e.g., HARQ feedback) to the 5G RAP layer, which may transmit the feedback information to the base station over the air.

FIG. 13A illustrates a system diagram 1300 of an example cross-RAT mobility scheme, according to some implementations. In accordance with the cross-RAT mobility scheme depicted in FIG. 13A, a UE is moving from point A (within coverage of 6G cell) to point B (within coverage of 5G cell, outside coverage of 6G cell). In such cases, the network may trigger the UE to perform mobility for primary serving cells between different RATs of the same base station by switching RAPs without having to change the configuration of other layers, e.g., non-radio-access stratum (NRAS) layers.

FIG. 13B illustrates a process flow 1301 of an example cross-RAT mobility scheme, according to some implementations. In accordance with the cross-RAT mobility scheme depicted in FIG. 13B, a connection is established between a UE and a cellular network (e.g., an xG base station). The UE may be configured with an xG NRAS layer, a 5G RAP layer, and a 6G RAP layer. If, for example, the 6G RAP is configured/active and the UE begins moving from point A to point B, the UE may provide a measurement report to the network. The measurement report may indicate that a 6G cell of the base station has a weak signal and a 5G cell of the base station has a good signal. This information may be provided by the MAP layer or the RRC layer.

In response, the cellular network may transmit a CRT handover request (5G cell, 5G_RAP_CONFIG) to the UE. Unlike existing protocols where an inter-RAT (IRAT) handover command is required, no change is needed for NRAS layer configurations; only the configuration of the RAT-specific RAP layer is changed. Accordingly, the xG NRAS of the UE may perform the 5G RAP handover and perform an initial access procedure (e.g., random access procedure) to establish communications with the 5G cell. Once complete, the 5G cell may respond with a CRT handover complete message to indicate that the handover was successful. This information may be conveyed from the 5G RAP layer of the UE to the xG NRAS layer, which may initiate 6G RAP release shortly thereafter.

FIG. 14 illustrates an example cross-RAT CA scheme 1400, according to some implementations. Currently, it is only possible for a UE to be served by multiple RAT component carriers (CCs) within the same connection (e.g., UE is establishing connection on 4G and having 3G cells added as secondary cells) via dual connectivity, where the UE is having two RATs active (e.g., LTE and NR) and being served via two different base stations, where each base station supports different radio protocol.

Using the techniques described herein, a single base station can (i) support multiple RATs via support of corresponding RAP layer and (ii) exchange data with an xG UE in the same connection via multiple CCs, where each carrier is operating on a different RAT, by having a single MAP layer transfer data over multiple RAP layers, as shown in FIG. 14. In the example cross-RAT CA scheme 1400, there is a single RAT (xG RAT) active, a single connection, a single base station, and multiple CCs across different RATs. Data on a specific bearer can be configured to be served with a subset of RAT CCs (e.g., to meet QoS requirements of the bearer).

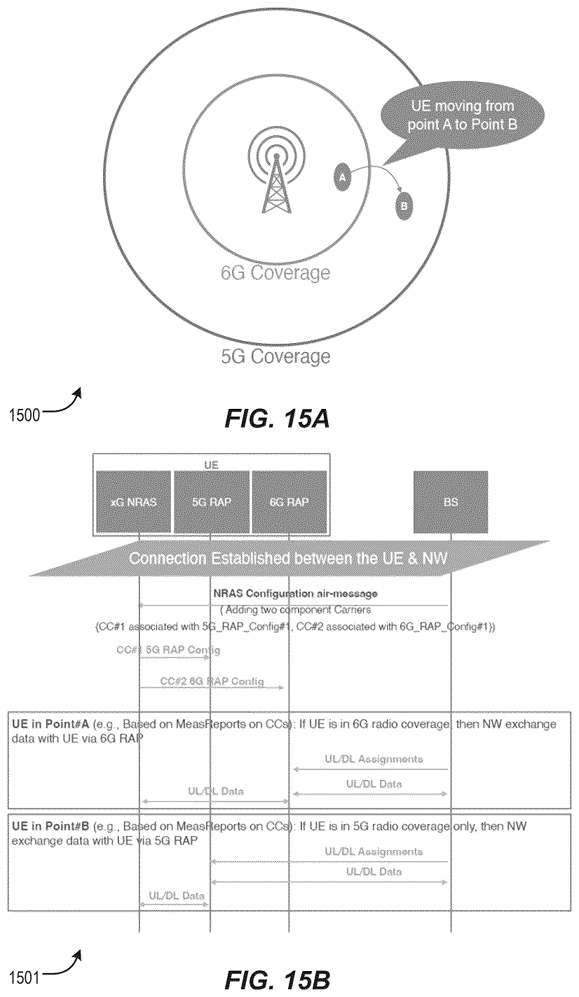

FIG. 15A illustrates a system diagram 1500 of an example cross-RAT CA scheme, according to some implementations. In accordance with the cross-RAT mobility scheme depicted in FIG. 15A, a UE is moving from point A (within coverage of 6G cell) to point B (within coverage of 5G cell, outside coverage of 6G cell). Using the xG and RAP functionality described herein, the network may configure the UE with more than one CC or secondary cell on different RATs by associating each CC with different RAT-specific RAP configurations. The network may schedule data transfer across these CCs based on different conditions like the UE channel conditions/coverage on each RAT or the load on each RAT based on the number of UEs accessing this RAT (e.g., if there are many legacy UEs connected to the base station via 4G, the network may serve xG UEs via 5G).

FIG. 15B illustrates a process flow 1501 of an example cross-RAT mobility scheme, according to some implementations. In accordance with the cross-RAT mobility scheme depicted in FIG. 15B, a connection is established between a UE and a base station associated with a cellular network. The UE may be configured with an xG NRAS protocol, a 5G RAP, and a 6G RAP. The base station may transmit an NRAS configuration message to add two CCs: CC #1 associated with 5G_RAP_CONFIG #1 and CC #2 associated with 6G_RAP_CONFIG #1. The xG NRAS protocol of the UE may apply the 5G_RAP_CONFIG #1 for CC #1 and the 6G_RAP_CONFIG #1 for CC #2.

When the UE is at point A (e.g., based on measurement reports on CCs) within 6G radio coverage, the network may exchange data with the UE via 6G RAP. For example, the 6G RAP of the UE may exchange uplink/downlink assignments and/or data with the base station, and the 6G RAP may provide this information to the xG NRAS protocol of the UE. When the UE is at point B (e.g., based on measurement reports on CCs) outside of 6G coverage but within 5G radio coverage, the network may exchange data with the UE via the 5G RAP. For example, the 5G RAP of the UE may exchange uplink/downlink assignments and/or data with the base station, and the 5G RAP may convey this information to the xG NRAS protocol of the UE.

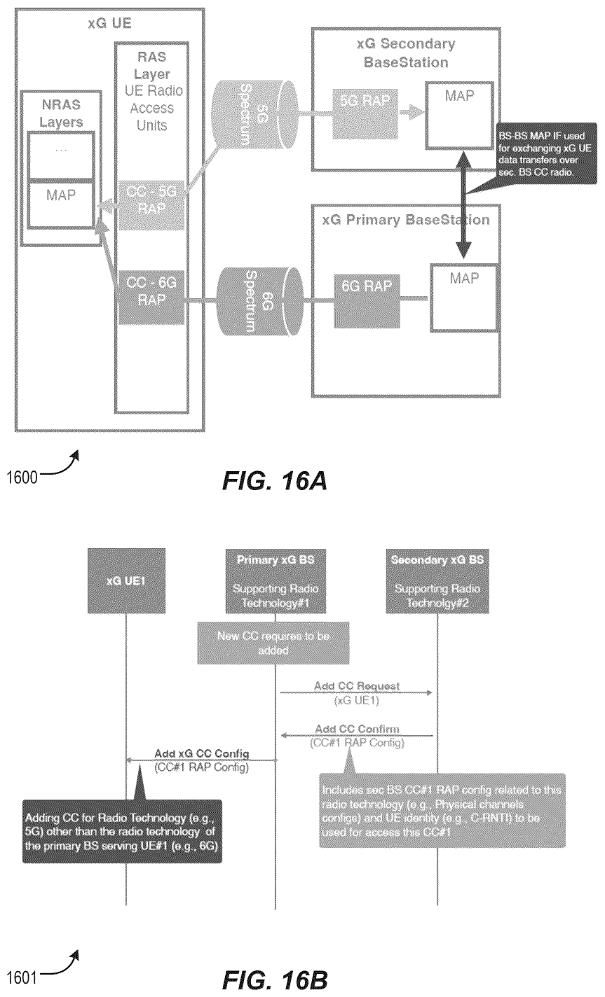

FIG. 16A illustrates a system diagram 1600 of an example cross-RAT CA scheme, according to some implementations. The cross-RAT CA scheme depicted in FIG. 16A supports different RAT CCs across different base stations. xG UE data can be exchanged between primary and secondary base stations via base station MAP-MAP interface. This base station to base station MAP interface can be used for exchanging xG UE data transfers over secondary base station CC RAT.

FIG. 16B illustrates a process flow 1601 of an example cross-RAT CA scheme, according to some implementations. In accordance with the cross-RAT CA scheme depicted in FIG. 16B, a primary xG base station that supports RAT #1 (e.g., xG) may determine to add new CC(s) for xG UE1. The primary xG base station may transmit an Add CC request for xG UE1 to a secondary xG base station that supports RAT #2 (e.g., 5G). In response, the secondary xG base station may transmit an Add CC Confirm message back to the primary xG base station. The Add CC Confirm message may include the secondary base station CC #1 RAP Config related to this particular RAT (e.g., physical channel configurations) and UE identity data (e.g., C-RNTI) to use for accessing CC #1. In turn, the primary xG base station may transmit an Add xG CC Config message to add CC #1 for RAT #2 (e.g., 5G), which may be different from the RAT of the primary xG base station serving xG UE1.

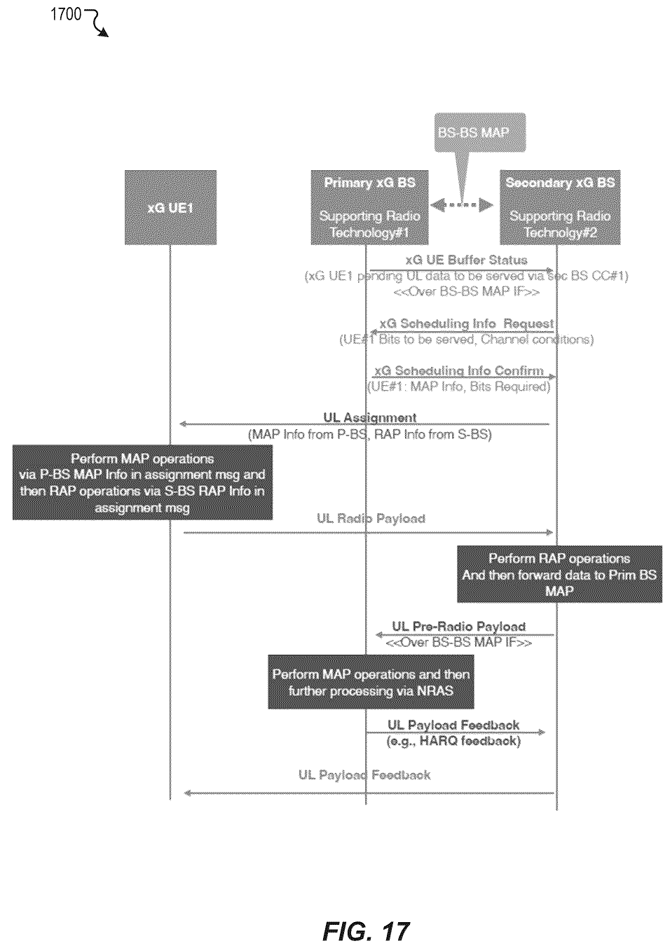

FIG. 17 illustrates an example signaling diagram 1700, according to some implementations. The signaling diagram 1700 depicted in FIG. 17 shows an uplink flow for cross-network node CC aggregation. The signaling diagram 1700 includes an xG UE1, a primary xG base station, and a secondary xG base station. The primary and secondary xG base stations may communicate via a MAP-MAP interface.

In accordance with the signaling diagram 1700, the primary xG base station informs the secondary xG base station of pending uplink data to be served via CC #1 of the primary base station. Based on resource availability, the secondary base station may allocate uplink resources for xG UE and request MAP information from the primary base station. In response, the primary base station sends the requested MAP information to the secondary base station, along with the bits to be served.

The xG UE then prepares a radio payload by (i) performing MAP operations using the MAP information provided by the primary base station and (ii) performing RAP operations using RAP information provided by the secondary base station. The secondary base station performs the RAP operations and then provides the pre-radio payload to the primary base station for further processing. The primary base station performs the MAP operations and then provides payload processing feedback (e.g., HARQ feedback) to the secondary base station.

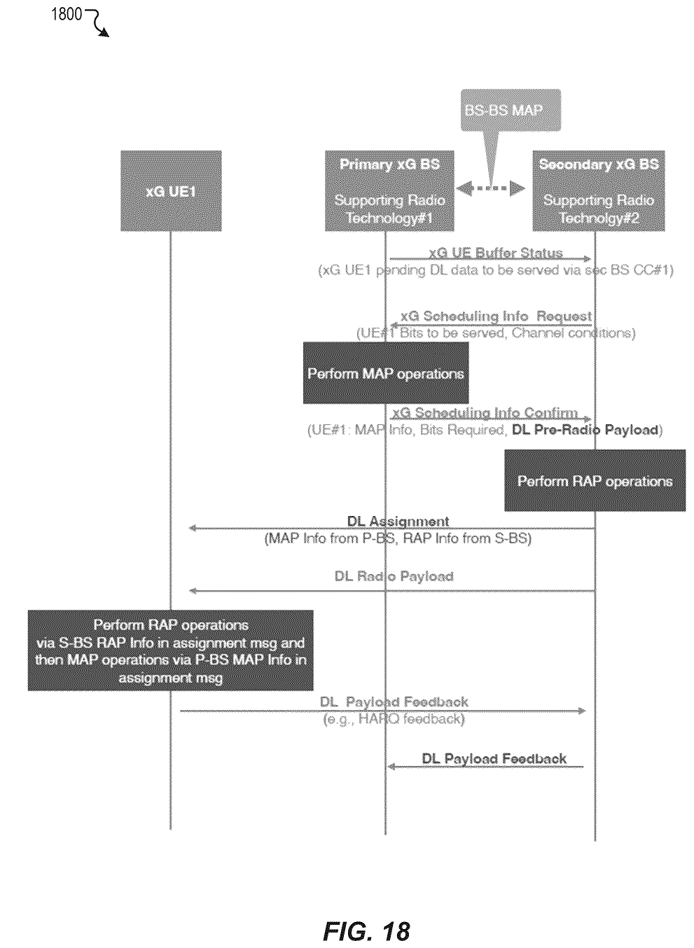

FIG. 18 illustrates an example signaling diagram 1800, according to some implementations. The signaling diagram 1800 depicted in FIG. 18 shows a downlink flow for cross-network node CC aggregation. The signaling diagram 1800 includes an xG UE1, a primary xG base station, and a secondary xG base station. The primary and secondary xG base stations may communicate via a MAP-MAP interface.

In accordance with the signaling diagram 1800, the primary base station informs the secondary base station of pending downlink data to be served via CC #1 of the secondary base station. In response, the secondary base station transmits an xG scheduling information request to the primary base station. The xG scheduling information request indicates UE #1 bits to be served and downlink channel conditions. Accordingly, the primary base station performs MAP operations using the information provided by the secondary base station and transmits an xG scheduling information confirmation message to the secondary base station. The xG scheduling information confirmation message indicates MAP information, bits required, and downlink pre-radio payload.

In turn, the secondary base station performs RAP operations using the information provided by the primary base station and transmits downlink assignment information (MAP information from primary base station, RAP information from the secondary base station) to the xG UE. Thereafter, the secondary base station transmits the downlink radio payload to the xG UE via CC #1. The xG UE performs RAP operations via the RAP of the secondary base station using the RAP information in the assignment message. The xG UE performs MAP operations using the MAP information provided by the primary base station and included in the assignment message. The xG UE then generates and transmits downlink payload feedback (e.g., HARQ feedback) for the downlink radio payload to the secondary base station, which relays the downlink payload feedback to the primary base station.

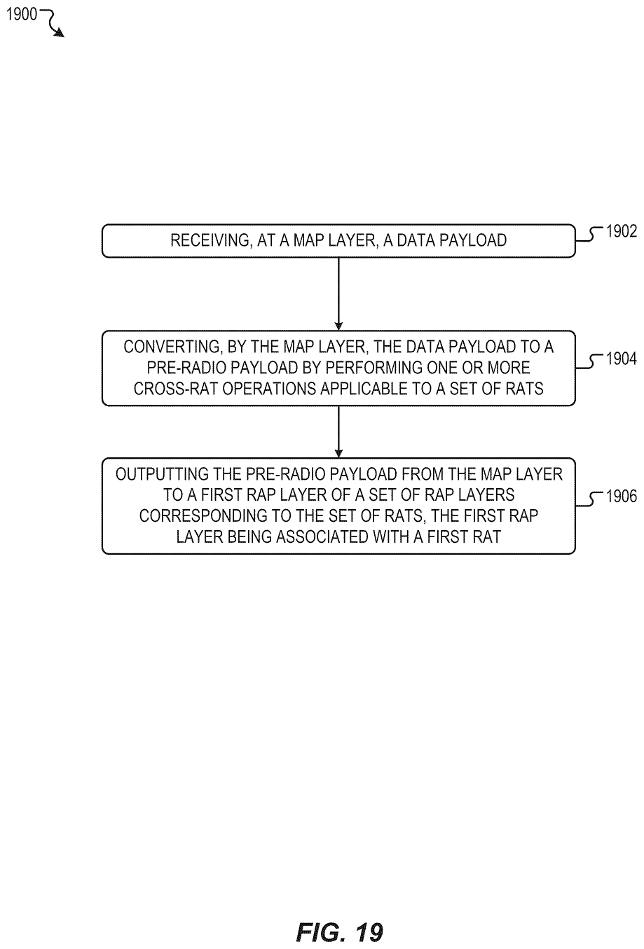

FIG. 19 illustrates a flowchart of an example method 1900, according to some implementations. For clarity of presentation, the description that follows generally describes method 1900 in the context of the other figures in this description. For example, method 1900 can be performed by the UE 102 of FIG. 1, or any suitable system, environment, software, hardware, etc. In some implementations, various steps of method 1900 can be run in parallel, in combination, in loops, or in any order. The example method 1900 shown in FIG. 19 can be modified or reconfigured to include additional, fewer, or different steps (not shown in FIG. 19), which can be performed in the order shown or in a different order.

At 1902, the method 1900 includes receiving, at a MAP layer, a data payload.

At 1904, the method 1900 includes converting, by the MAP layer, the data payload to a pre-radio payload by performing one or more cross-RAT operations applicable to a set of RATs.

At 1906, the method 1900 includes outputting the pre-radio payload from the MAP layer to a first RAP layer of a set of RAP layers corresponding to the set of RATs, the first RAP layer being associated with the first RAT.

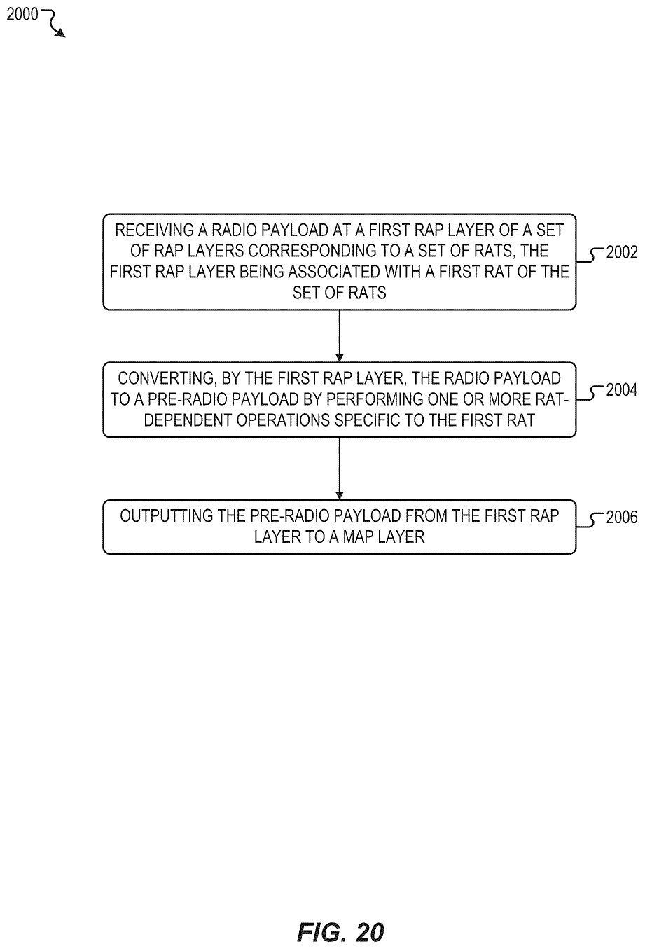

FIG. 20 illustrates a flowchart of an example method 2000, according to some implementations. For clarity of presentation, the description that follows generally describes method 2000 in the context of the other figures in this description. For example, method 2000 can be performed by the UE 102 of FIG. 1, or any suitable system, environment, software, hardware, etc. In some implementations, various steps of method 2000 can be run in parallel, in combination, in loops, or in any order. The example method 2000 shown in FIG. 20 can be modified or reconfigured to include additional, fewer, or different steps (not shown in FIG. 20), which can be performed in the order shown or in a different order.

At 2002, the method 2000 includes receiving a radio payload at a first RAP layer of a set of RAP layers corresponding to a set of RATs.

At 2004, the method 2000 includes converting, by the first RAP layer, the radio payload to a pre-radio payload by performing one or more RAT-dependent operations specific to a first RAT of the set of RATs.

At 2006, the method 2000 includes outputting the pre-radio payload from the first RAP layer to a MAP layer.

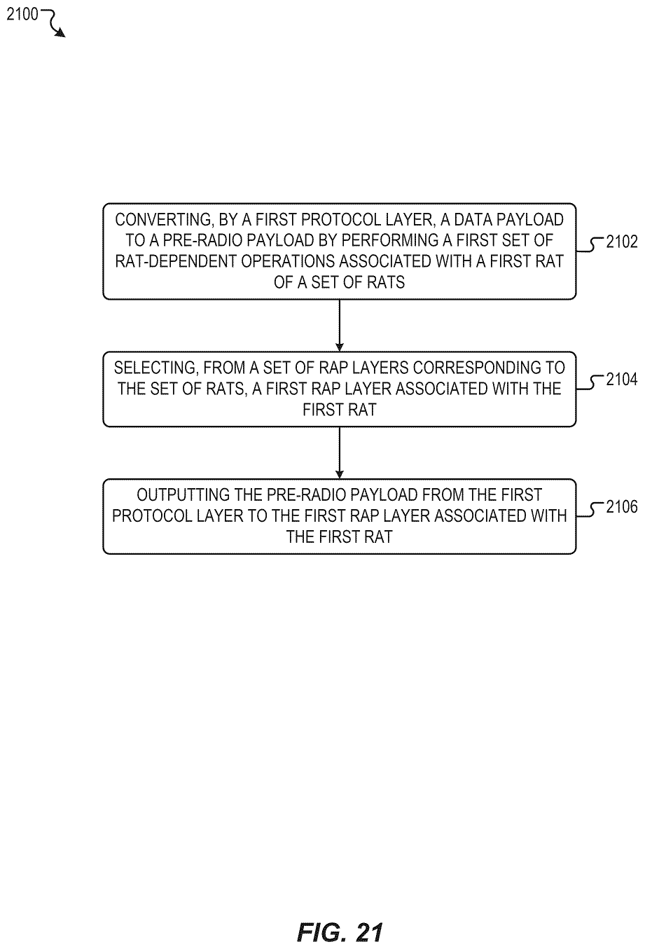

FIG. 21 illustrates a flowchart of an example method 2100, according to some implementations. For clarity of presentation, the description that follows generally describes method 2100 in the context of the other figures in this description. For example, method 2100 can be performed by the base station 104 of FIG. 1, or any suitable system, environment, software, hardware, etc. In some implementations, various steps of method 2100 can be run in parallel, in combination, in loops, or in any order. The example method 2100 shown in FIG. 21 can be modified or reconfigured to include additional, fewer, or different steps (not shown in FIG. 21), which can be performed in the order shown or in a different order.

At 2102, the method 2100 includes converting, by a first protocol layer, a data payload to a pre-radio payload by performing a first set of RAT dependent operations associated with a first RAT of a set of RATs.

At 2104, the method 2100 includes selecting, from a set of RAP layers corresponding to the set of RATs, a first RAP layer associated with the first RAT.

At 2106, the method 2100 includes outputting the pre-radio payload from the first protocol layer to the first RAP layer associated with the first RAT.

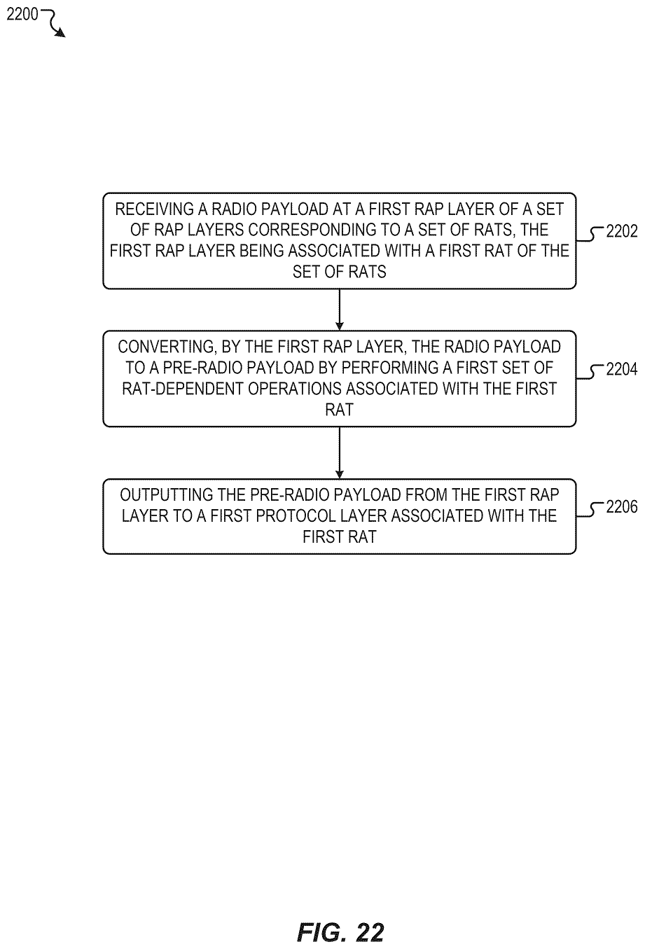

FIG. 22 illustrates a flowchart of an example method 2200, according to some implementations. For clarity of presentation, the description that follows generally describes method 2200 in the context of the other figures in this description. For example, method 2200 can be performed by the base station 104 of FIG. 1, or any suitable system, environment, software, hardware, etc. In some implementations, various steps of method 2200 can be run in parallel, in combination, in loops, or in any order. The example method 2200 shown in FIG. 22 can be modified or reconfigured to include additional, fewer, or different steps (not shown in FIG. 22), which can be performed in the order shown or in a different order.

At 2202, the method 2200 includes receiving a radio payload at a first RAP layer of a set of RAP layers corresponding to a set of RATs, the first RAP layer being associated with a first RAT of the set of RATs.

At 2204, the method 2200 includes converting, by the first RAP layer, the radio payload to a pre-radio payload by performing a first set of RAT-dependent operations associated with a first RAT of the set of RATs.

At 2206, the method 2200 includes outputting the pre-radio payload from the first RAP layer to a first protocol layer associated with the first RAT.

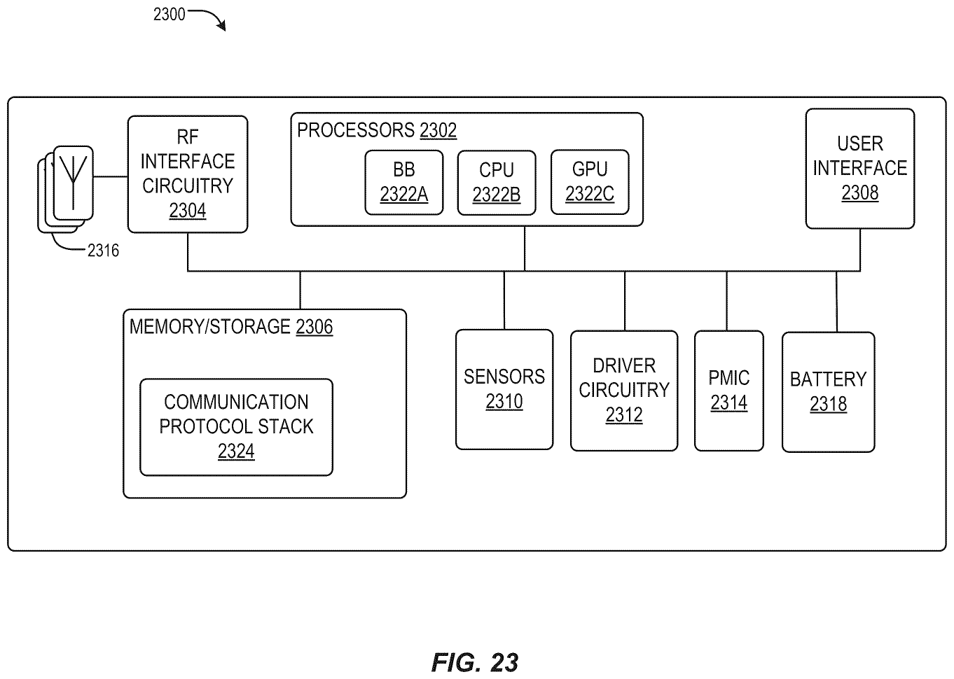

FIG. 23 illustrates an example UE 2300. The UE 2300 may be similar to and substantially interchangeable with UE 102 of FIG. 1.

The UE 2300 may be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 2300 may include any/all of processor 2302, RF interface circuitry 2304, memory/storage 2306, user interface 2308, sensors 2310, driver circuitry 2312, power management integrated circuit (PMIC) 2314, one or more antenna(s) 2316, and battery 2318. The components of the UE 2300 may be implemented as integrated circuits (ICs), portions thereof, discrete electronic devices, or other modules, logic, hardware, software, firmware, or a combination thereof. The block diagram of FIG. 23 is intended to show a high-level view of some of the components of the UE 2300. However, some of the components shown may be omitted, additional components may be present, and a different arrangement of the components shown may occur in other implementations.

The components of the UE 2300 may be coupled with various other components over one or more interconnects 2320, which may represent any type of interface, input/output, bus (local, system, or expansion), transmission line, trace, optical connection, etc., that allows various circuit components (on common or different chips or chipsets) to interact with one another.

The processor 2302 may include one or more processors. For example, the processor 2302 may include processor circuitry such as, for example, baseband processor circuitry (BB) 2322A, central processor unit circuitry (CPU) 2322B, and graphics processor unit circuitry (GPU) 2322C. The processor 2302 may include any type of circuitry or processor circuitry that executes or otherwise operates computer-executable instructions, such as program code, software modules, or functional processes from memory/storage 2306 to cause the UE 2300 to perform operations as described herein.

In some implementations, the baseband processor circuitry 2322A may access a communication protocol stack 2324 in the memory/storage 2306 to communicate over a 3GPP compatible network. In general, the baseband processor circuitry 2322A may access the communication protocol stack to: perform user plane functions at a PHY layer, MAC layer, RLC layer, PDCP layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 2304. The baseband processor circuitry 2322A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 2306 may include one or more non-transitory, computer-readable media that includes instructions (for example, communication protocol stack 2324) that may be executed by the processor 2302 to cause the UE 2300 to perform various operations described herein. The memory/storage 2306 include any type of volatile or non-volatile memory that may be distributed throughout the UE 2300. In some implementations, some of the memory/storage 2306 may be located on the processor 2302 itself (for example, L1 and L2 cache), while other memory/storage 2306 is external to the processor 2302 but accessible thereto via a memory interface. The memory/storage 2306 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 2304 may include transceiver circuitry and radio frequency front module (RFEM) that allows the UE 2300 to communicate with other devices over a radio access network. The RF interface circuitry 2304 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 2316 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 2316. In various implementations, the RF interface circuitry 2304 may be configured to transmit/receive signals in a manner compatible with NR access technologies.

The antenna(s) 2316 may include one or more antenna elements to convert electrical signals into radio waves to travel through the air and to convert received radio waves over the air into electrical signals. In some implementations, the antenna elements may be arranged into one or more antenna panels. The antenna(s) 2316 may have antenna panels that are omnidirectional, directional, or a combination thereof, to enable beamforming and multiple input, multiple output communications. The antenna(s) 2316 may include any/all of microstrip antennas, printed antennas fabricated on the surface of one or more printed circuit boards, patch antennas, phased array antennas, etc. The antenna(s) 2316 may have one or more panels designed for one or more specific frequency bands, such as bands in FR1 or FR2.

The user interface 2308 includes various input/output (I/O) devices designed to enable user interaction with the UE 2300. The user interface 2308 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 2300.

The sensors 2310 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2312 may include software and hardware elements that operate to control particular devices that are embedded in the UE 2300, attached to the UE 2300, or otherwise communicatively coupled with the UE 2300. The driver circuitry 2312 may include individual drivers allowing other components to interact with or control various input/output (I/O) devices that may be present within, or connected to, the UE 2300. For example, driver circuitry 2312 may include a display driver to control and allow access to a display device, a touchscreen driver to control and allow access to a touchscreen interface, sensor drivers to obtain sensor readings of sensors 2310 and control and allow access to sensors 2310, drivers to obtain actuator positions of electro-mechanic components or control and allow access to the electro-mechanic components, a camera driver to control and allow access to an embedded image capture device, audio drivers to control and allow access to one or more audio devices.

The PMIC 2314 may manage power provided to various components of the UE 2300. In particular, with respect to the processor 2302, the PMIC 2314 may control power-source selection, voltage scaling, battery charging, or DC-to-DC conversion.

In some implementations, the PMIC 2314 may control, or otherwise be part of, various power saving mechanisms of the UE 2300. A battery 2318 may power the UE 2300, although in some examples the UE 2300 may be mounted deployed in a fixed location, and may have a power supply coupled to an electrical grid. The battery 2318 may be a lithium ion battery, a metal-air battery, such as a zinc-air battery, an aluminum-air battery, a lithium-air battery, and the like. In some implementations, such as in vehicle-based applications, the battery 2318 may be a typical lead-acid automotive battery.

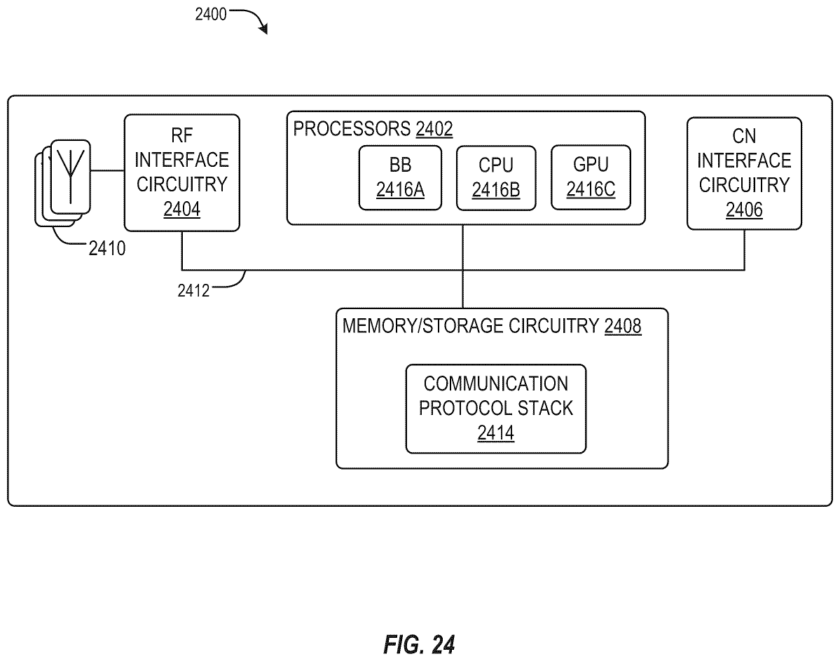

FIG. 24 illustrates an example access node 2400 (e.g., a base station or gNB), according to some implementations. The access node 2400 may be similar to and substantially interchangeable with base station 104. The access node 2400 may include one or more of processor 2402, RF interface circuitry 2404, core network (CN) interface circuitry 2406, memory/storage circuitry 2408, and one or more antenna(s) 2410. The processor 2402 may include any type of circuitry or processor circuitry that executes or otherwise operates computer-executable instructions, such as program code, software modules, or functional processes from memory/storage circuitry 2408 to cause the access node 2400 to perform operations as described herein.

The components of the access node 2400 may be coupled with various other components over one or more interconnects 2412. The processor 2402, RF interface circuitry 2404, memory/storage circuitry 2408 (including communication protocol stack 2414), antenna(s) 2410, and interconnects 2412 may be similar to like-named elements shown and described with respect to FIG. 23. For example, the processor 2402 may include processor circuitry such as, for example, baseband processor circuitry (BB) 2416A, central processor unit circuitry (CPU) 2416B, and graphics processor unit circuitry (GPU) 2416C.

The CN interface circuitry 2406 may provide connectivity to a core network, for example, a 5th Generation Core network (5GC) using a 5GC-compatible network interface protocol such as carrier Ethernet protocols, or some other suitable protocol. Network connectivity may be provided to/from the access node 2400 via a fiber optic or wireless backhaul. The CN interface circuitry 2406 may include one or more dedicated processors or FPGAs to communicate using one or more of the aforementioned protocols. In some implementations, the CN interface circuitry 2406 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 2400 that operates in an NR or 5G system (for example, a gNB), and the term “E-UTRAN node” or the like may refer to an access node 2400 that operates in an LTE or 4G system (e.g., an eNB). According to various implementations, the access node 2400 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 2400 may be implemented as one or more software entities running on server computers as part of a virtual network, which may be referred to as a CRAN and/or a virtual baseband unit pool (vBBUP). In V2X scenarios, the access node 2400 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below.

Example 1 is a method including: receiving, at a MAP layer, a data payload; converting, by the MAP layer, the data payload to a pre-radio payload by performing one or more cross-RAT operations common to a set of RATs; outputting the pre-radio payload from the MAP layer to a first RAP layer of a set of RAP layers corresponding to the set of RATs; and converting, by the first RAP layer, the pre-radio payload to a radio payload by performing one or more RAT-dependent operations specific to a first RAT of the set of RATs.

Example 2 includes the method of example 1, further including transmitting, via RF circuitry, the radio payload generated by the first RAP layer associated with the first RAT.

Example 3 includes the method of any of examples 1 to 2, where the one or more cross-RAT operations include at least one of HARQ processing, CRC processing, code block segmentation, code block CRC processing, channel coding, rate matching, code block concatenation, or scrambling.

Example 4 includes the method of any of examples 1 to 3, where the one or more RAT-dependent operations include at least one of RF operations, resource mapping, antenna port mapping, layer mapping, or modulation.

Example 5 includes the method of any of examples 1 to 4, where the set of RATs includes a 3G RAT, a 4G RAT, a 5G RAT, a 6G RAT, a 7G RAT, and a WLAN RAT (e.g., Wi-Fi).

Example 6 includes the method of any of examples 1 to 5, where the MAP layer is configured to perform RAT-independent MAC layer operations including at least one of multiplexing and prioritization, discontinuous reception, feedback and soft-combining, or serving cell activation and deactivation.

Example 7 includes the method of any of examples 1 to 6, where the MAP layer is configured to perform RAT-independent PHY layer operations including at least one of checksum generation, channel coding, rate matching, or scrambling.

Example 8 includes the method of any of examples 1 to 7, where the first RAP layer is configured to perform at least one of radio frame structure configuration, cell detection and measurement, modulation, layer mapping and pre-coding, resource mapping, measurements and CQI reporting, random access, uplink TA maintenance, requesting uplink resources, feedback transmission, or physical channel validation.

Example 9 includes the method of any of examples 1 to 8, further including receiving CRT-AI indicating whether cross-RAT access is enabled for a cell.

Example 10 includes the method of example 9, further including selecting the first RAP layer from the set of RAP layers based at least on the CRT-AI.

Example 11 includes the method of example 10, further including receiving broadcast information via the cell using the selected first RAP layer in accordance with the CRT-AI.

Example 12 includes the method of any of examples 1 to 11, further including transmitting a request for mandatory system information messages associated with the first RAT.

Example 13 includes the method of any of examples 1 to 12, further including receiving the mandatory system information messages using the first RAP layer associated with the first RAT in accordance with the request.

Example 14 includes the method of any of examples 1 to 13, further including receiving a broadcast message indicating a list of physical radio resources or preamble IDs to use for accessing a cellular network via the first RAT.

Example 15 includes the method of example 14, further including transmitting the radio payload to the cellular network using at least one physical radio resource of preamble ID indicated by the broadcast message.

Example 16 includes the method of any of examples 1 to 15, further including receiving an assignment message indicating at least one of a payload size, HARQ parameters, a channel coding rate, code block creation parameters, or scrambling parameters to use for the first RAT.

Example 17 includes the method of example 16, where the assignment message further indicates one or more modulation scheme parameters, physical radio resources, antenna mapping parameters, or RF parameters to use for a second RAT of the set of RATs.

Example 18 includes the method of example 17, where the assignment message is received using the first RAT or the second RAT.

Example 19 includes the method of any of examples 16 to 18, where the assignment includes MAP-level information and RAP-level information to use for transmission, re-transmission, or reception of payloads associated with the first RAT.

Example 20 includes the method of any of examples 1 to 19, further including receiving a cross-RAT handover request message from a cellular network.

Example 21 includes the method of example 20, further including executing a cross-RAT handover from a first cell associated with the first RAT to a second cell associated with a second RAT in accordance with the cross-RAT handover request message.

Example 22 includes the method of example 21, where executing the cross-RAT handover includes performing the cross-RAT handover from the first cell to the second cell without reconfiguring one or more NRAS protocol layers.

Example 23 includes the method of any of examples 1 to 22, further including exchanging data with a cellular network via a set of component carriers corresponding to the set of RATs using the set of RAP layers in accordance with a cross-RAT CA scheme.

Example 24 includes the method of example 23, further including receiving control signaling that configures one or more parameters for the cross-RAT CA scheme, where the control signaling associates the set of component carriers with the set of RAP layers corresponding to the set of RATs.

Example 25 includes the method of any of examples 1 to 24, further including receiving an uplink assignment message containing (i) MAP-level information associated with a first base station that supports the first RAT and (ii) RAP-level information associated with a second base station that supports a second RAT of the set of RATs.

Example 26 includes the method of example 25, further including: transmitting the radio payload to the first base station using the first RAT; and receiving feedback for the radio payload from the second base station using the second RAT.

Example 27 is an apparatus including: one or more processors; and memory storing instructions that, when executed by the one or more processors, cause the apparatus to perform the method of any of examples 1-26.

Example 28 is a UE including at least one processor configured to perform the method of any of examples 1-26.

Example 29 is a baseband processor configured to perform the method of any of examples 1-26.

Example 30 is a non-transitory computer-readable medium storing instructions that, when executed by one or more processors, cause the one or more processors to perform the method of any of examples 1-26.

Example 31 is a method including: receiving, at a first RAP layer of a set of RAP layers corresponding to a set of RATs, a radio payload; converting, by the first RAP layer, the radio payload to a pre-radio payload by performing one or more RAT-dependent operations specific to a first RAT of the set of RATs; outputting the pre-radio payload from the first RAP layer to a MAP layer; and converting, by the MAP layer, the pre-radio payload to a data payload by performing one or more cross-RAT operations common to the set of RATs.

Example 32 includes the method of example 31, further including outputting the data payload from the MAP layer to a higher protocol layer.

Example 33 includes the method of any of examples 1 to 32, further including receiving a downlink assignment message containing (i) MAP-level information associated with a first base station that supports the first RAT and (ii) RAP-level information associated with a second base station that supports a second RAT of the set of RATs.

Example 34 includes the method of example 33, further including: receiving the radio payload from the first base station using the first RAT; and transmitting feedback for the radio payload to the second base station using the second RAT.

Example 35 is an apparatus including: one or more processors; and memory storing instructions that, when executed by the one or more processors, cause the apparatus to perform the method of any of examples 31-34.

Example 36 is a UE including at least one processor configured to perform the method of any of examples 31-34.

Example 37 is a baseband processor configured to perform the method of any of examples 31-34.

Example 38 is a non-transitory computer-readable medium storing instructions that, when executed by one or more processors, cause the one or more processors to perform the method of any of examples 31-34.

Example 39 is a method including: converting, by a first protocol layer, a data payload to a pre-radio payload by performing a first set of RAT-dependent operations associated with a first RAT of a set of RATs; selecting, from a set of RAP layers corresponding to the set of RATs, a first RAP layer associated with the first RAT; outputting the pre-radio payload from the first protocol layer to the first RAP layer associated with the first RAT; and converting, by the first RAP layer, the pre-radio payload to a radio payload by performing a second set of RAT-dependent operations associated with the first RAT.

Example 40 includes the method of example 39, further including transmitting, via RF circuitry, the radio payload generated by the first RAP layer associated with the first RAT.

Example 41 includes the method of example 40, where transmitting the radio payload includes transmitting the radio payload using the first RAP layer associated with the first RAT, the radio payload including data associated with a second RAT of the set of RATs.

Example 42 includes the method of any of examples 39 to 41, where selecting the first RAP layer includes selecting the first RAP layer from the set of RAP layers based at least on a RNTI assigned to a UE.

Example 43 is an apparatus including: one or more processors; and memory storing instructions that, when executed by the one or more processors, cause the apparatus to perform the method of any of examples 39-42.

Example 44 is a base station including at least one processor configured to perform the method of any of examples 39-42.

Example 45 is a baseband processor configured to perform the method of any of examples 39-42.

Example 46 is a non-transitory computer-readable medium storing instructions that, when executed by one or more processors, cause the one or more processors to perform the method of any of examples 39-42.

Example 47 is a method including: receiving, at a first RAP layer of a set of RAP layers corresponding to a set of RATs, a radio payload; converting, by the first RAP layer, the radio payload to a pre-radio payload by performing a first set of RAT-dependent operations associated with a first RAT of the set of RATs; outputting the pre-radio payload from the first RAP layer to a first protocol layer associated with the first RAT; and converting, by the first protocol layer, the pre-radio payload to a data payload by performing a second set of RAT-dependent operations associated with the first RAT.

Example 48 includes the method of example 47, where the first protocol layer includes a PHY layer associated with a 4G RAT or a 5G RAT.

Example 49 includes the method of example 48, where the higher protocol layer includes a MAP layer associated with a 6G RAT.

Example 50 includes the method of any of examples 47 to 49, further including selecting the first RAP layer from the set of RAP layers based at least on a RNTI assigned to a UE.

Example 51 includes the method of any of examples 47 to 50, further including transmitting a broadcast message indicating a list of physical radio resources or preamble IDs to use for accessing a cellular network via the first RAT.

Example 52 includes the method of any of examples 47 to 51, further including selecting the first RAP layer to process the radio payload based at least on a physical radio resource or preamble ID associated with the radio payload.

Example 53 includes the method of any of examples 47 to 52, further including exchanging data between a first base station associated with the first RAT and a second base station associated with a second RAT via a MAP interface between the first base station and the second base station.

Example 54 is an apparatus including: one or more processors; and memory storing instructions that, when executed by the one or more processors, cause the apparatus to perform the method of any of examples 47-53.

Example 55 is a base station including at least one processor configured to perform the method of any of examples 47-53.

Example 56 is a baseband processor configured to perform the method of any of examples 47-53.

Example 57 is a non-transitory computer-readable medium storing instructions that, when executed by one or more processors, cause the one or more processors to perform the method of any of examples 47-53.

Example 58 is a method including: receiving, at a MAP layer, a data payload; converting, by the MAP layer, the data payload to a pre-radio payload by performing one or more cross-RAT operations applicable to a set of RATs; and outputting the pre-radio payload from the MAP layer to a first RAP layer of a set of RAP layers corresponding to the set of RATs, the first RAP layer being associated with a first RAT.

Example 59 includes the method of example 58, where the one or more cross-RAT operations include at least one of HARQ processing, CRC processing, code block segmentation, code block CRC processing, channel coding, rate matching, code block concatenation, or scrambling.

Example 60 includes the method of any of examples 58-59, further including converting, by the first RAP layer, the pre-radio payload to a radio payload by performing one or more RAT-dependent operations specific to a first RAT of the set of RATs, the first RAP layer being associated with the first RAT, where the one or more RAT-dependent operations include at least one of RF operations, resource mapping, antenna port mapping, layer mapping, or modulation.

Example 61 includes the method of example 60, further including transmitting, via RF circuitry, the radio payload generated by the first RAP layer associated with the first RAT.

Example 62 includes the method of any of examples 58-61, where the set of RATs includes a 3G RAT, a 4G RAT, a 5G RAT, a 6G RAT, a 7G RAT, and a WLAN RAT.

Example 63 includes the method of any of examples 58-62, where the MAP layer is configured to perform RAT-independent MAC layer operations including at least one of multiplexing and prioritization, discontinuous reception, feedback and soft-combining, or serving cell activation and deactivation.

Example 64 includes the method of any of examples 58-63, where the MAP layer is configured to perform RAT-independent PHY layer operations including at least one of checksum generation, channel coding, rate matching, or scrambling.

Example 65 includes the method of any of examples 58-64, where the first RAP layer is configured to perform at least one of radio frame structure configuration, cell detection and measurement, modulation, layer mapping and pre-coding, resource mapping, measurements and CQI reporting, random access, uplink TA maintenance, requesting uplink resources, feedback transmission, or physical channel validation.

Example 66 includes the method of any of examples 58-65, further including receiving CRT-AI indicating whether cross-RAT access is enabled for a cell.

Example 67 includes the method of example 66, further including selecting the first RAP layer from the set of RAP layers based on the CRT-AI.

Example 68 includes the method of example 67, further including receiving broadcast information via the cell using the selected first RAP layer in accordance with the CRT-AI.

Example 69 includes the method of any of examples 58-68, further including transmitting a request for mandatory system information messages associated with a second RAT.

Example 70 includes the method of example 69, further including receiving the mandatory system information messages using the first RAP layer associated with the first RAT in accordance with the request.

Example 71 includes the method of any of examples 58-70, further including receiving a broadcast message indicating a list of physical radio resources or preamble IDs to use for accessing a cellular network via the first RAT.

Example 72 includes the method of example 71, further including transmitting a radio payload to the cellular network using at least one physical radio resource of preamble ID indicated by the broadcast message.

Example 73 includes the method of any of examples 58-72, further including receiving an assignment message indicating at least one of a payload size, HARQ parameters, a channel coding rate, code block creation parameters, or scrambling parameters to use for the first RAT.

Example 74 includes the method of example 73, where the assignment message further indicates one or more modulation scheme parameters, physical radio resources, antenna mapping parameters, or RF parameters to use for a second RAT of the set of RATs.

Example 75 includes the method of example 74, where the assignment message is received using the first RAT or the second RAT.

Example 76 is a method including: receiving a radio payload at a first RAP layer of a set of RAP layers corresponding to a set of RATs, the first RAP layer being associated with a first RAT of the set of RATs; converting, by the first RAP layer, the radio payload to a pre-radio payload by performing one or more RAT-dependent operations specific to the first RAT; and outputting the pre-radio payload from the first RAP layer to a MAP layer.

Example 77 is a method including: converting, by a first protocol layer, a data payload to a pre-radio payload by performing a first set of RAT-dependent operations associated with a first RAT of a set of RATs; selecting, from a set of RAP layers corresponding to the set of RATs, a first RAP layer associated with the first RAT; and outputting the pre-radio payload from the first protocol layer to the first RAP layer associated with the first RAT.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method comprising:
receiving, at a medium access protocol (MAP) layer, a data payload;
converting, by the MAP layer, the data payload to a pre-radio payload by performing one or more cross-radio access technology (RAT) operations applicable to a plurality of RATs; and
outputting the pre-radio payload from the MAP layer to a first radio access protocol (RAP) layer of a plurality of RAP layers corresponding to the plurality of RATs, the first RAP layer being associated with a first RAT.

2. The method of claim 1, wherein the one or more cross-RAT operations comprise at least one of hybrid automatic repeat request (HARQ) processing, cyclic redundancy check (CRC) processing, code block segmentation, code block CRC processing, channel coding, rate matching, code block concatenation, or scrambling.

3. The method of claim 1, further comprising converting, by the first RAP layer, the pre-radio payload to a radio payload by performing one or more RAT-dependent operations specific to a first RAT of the plurality of RATs, the first RAP layer being associated with the first RAT, wherein the one or more RAT-dependent operations comprise at least one of radio frequency (RF) operations, resource mapping, antenna port mapping, layer mapping, or modulation.

4. The method of claim 3, further comprising transmitting, via RF circuitry, the radio payload generated by the first RAP layer associated with the first RAT.

5. The method of claim 1, wherein the plurality of RATs comprises a third generation (3G) RAT, a fourth generation (4G) RAT, a fifth generation (5G) RAT, a sixth generation (6G) RAT, a seventh generation (7G) RAT, and a wireless local area network (WLAN) RAT.

6. The method of claim 1, wherein the MAP layer is configured to perform RAT-independent medium access control (MAC) layer operations comprising at least one of multiplexing and prioritization, discontinuous reception, feedback and soft-combining, or serving cell activation and deactivation.

7. The method of claim 1, wherein the MAP layer is configured to perform RAT-independent physical (PHY) layer operations comprising at least one of checksum generation, channel coding, rate matching, or scrambling.

8. The method of claim 1, wherein the first RAP layer is configured to perform at least one of radio frame structure configuration, cell detection and measurement, modulation, layer mapping and pre-coding, resource mapping, measurements and channel quality indicator (CQI) reporting, random access, uplink timing advance (TA) maintenance, requesting uplink resources, feedback transmission, or physical channel validation.

9. The method of claim 1, further comprising receiving cross-radio technology access information (CRT-AI) indicating whether cross-RAT access is enabled for a cell.

10. The method of claim 9, further comprising selecting the first RAP layer from the plurality of RAP layers based at least on the CRT-AI.

11. The method of claim 10, further comprising receiving broadcast information via the cell using the selected first RAP layer in accordance with the CRT-AI.

12. The method of claim 1, further comprising transmitting a request for mandatory system information messages associated with a second RAT.

13. The method of claim 12, further comprising receiving the mandatory system information messages using the first RAP layer associated with the first RAT in accordance with the request.

14. The method of claim 1, further comprising receiving a broadcast message indicating a list of physical radio resources or preamble identifiers (IDs) to use for accessing a cellular network via the first RAT.

15. The method of claim 14, further comprising transmitting a radio payload to the cellular network using at least one physical radio resource of preamble ID indicated by the broadcast message.

16. The method of claim 1, further comprising receiving an assignment message indicating at least one of a payload size, hybrid automatic repeat request (HARQ) parameters, a channel coding rate, code block creation parameters, or scrambling parameters to use for the first RAT.

17. The method of claim 16, wherein the assignment message further indicates one or more modulation scheme parameters, physical radio resources, antenna mapping parameters, or radio frequency (RF) parameters to use for a second RAT of the plurality of RATs.

18. The method of claim 17, wherein the assignment message is received using the first RAT or the second RAT.

19. A method comprising:
receiving a radio payload at a first radio access protocol (RAP) layer of a plurality of RAP layers corresponding to a plurality of radio access technologies (RATs), the first RAP layer being associated with a first RAT of the plurality of RATs;
converting, by the first RAP layer, the radio payload to a pre-radio payload by performing one or more RAT-dependent operations specific to the first RAT; and
outputting the pre-radio payload from the first RAP layer to a medium access protocol (MAP) layer.

20. A method comprising:
converting, by a first protocol layer, a data payload to a pre-radio payload by performing a first set of radio access technology (RAT)-dependent operations associated with a first RAT of a plurality of RATs;
selecting, from a plurality of RAP layers corresponding to the plurality of RATs, a first radio access protocol (RAP) layer associated with the first RAT; and
outputting the pre-radio payload from the first protocol layer to the first RAP layer associated with the first RAT.
